(19) United States
(12) Patent Application Publication
(10) Pub. No.: US 2026/0339022 A1
(43) Pub. Date: Oct. 29, 2026

(54) OPTICAL WAVEGUIDE SUBSTRATE AND OPTICAL DEVICE

(71) Applicant: AGC Inc., Tokyo (JP)

(72) Inventors: Kazuki KANEHARA, Tokyo (JP); Seiki OHARA, Tokyo (JP); Hiroyuki MIENO, Tokyo (JP)

(73) Assignee: AGC Inc., Tokyo (JP)

(21) Appl. No.: 19/718,816

(22) Filed: Jun. 24, 2026

Related U.S. Application Data
(63) Continuation of application No. PCT/JP2024/043591, filed on Dec. 10, 2024.

(30) Foreign Application Priority Data
Dec. 25, 2023 (JP) 2023-218368

(51) Int. Cl. G02B 6/122; G02B 6/12

(52) U.S. Cl. CPC G02B 6/122; G02B 2006/12038; G02B 2006/12069; G02B 2006/12147

(57) ABSTRACT

The present invention relates to an optical waveguide substrate containing a cladding layer A and a cladding layer B bonded to the cladding layer A, in which the cladding layer A contains a glass having a cladding region A and a core region having a refractive index higher than that of the cladding region A, the glass constituting the cladding region A and the glass constituting the core region satisfy a specific relation regarding the content ratio of Na₂O and Ag₂O, the core region is located in a region including a part of a surface of the cladding layer A on the cladding layer B side, and the cladding layer B contains a cladding region B having a refractive index lower than that of the core region of the cladding layer A.

### CROSS-REFERENCE TO RELATED APPLICATIONS

This is a continuation of International Application No. PCT/JP2024/043591 filed on Dec. 10, 2024, and claims priority under 35 USC 119 from Japanese Patent Application No. 2023-218368 filed on Dec. 25, 2023, the contents of which are incorporated herein by reference.

### TECHNICAL FIELD

The present invention relates to an optical waveguide substrate and an optical device including the optical waveguide substrate.

### BACKGROUND ART

In recent years, a high-speed and large-capacity transmission technique has attracted attention, starting with 5G and 6G wireless transmission such as microwaves and millimeter waves. In order to realize larger capacity and lower delay transmission, an “optoelectric fusion technique” has been studied in which a part of communication that has been electrically performed inside a personal computer or the like is optically performed.

By using an optical signal instead of an electric signal, low power consumption, large capacity communication, and low delay transmission are expected.

In the optoelectric fusion technique, a substrate capable of transmitting both electricity and light is required. As such a substrate, various materials have been studied, such as a Si—Ge substrate in which SiO₂ is doped with Ge, a Si thin wire substrate in which Si is surrounded by SiO₂, and a polymer substrate in which different kinds of polymers are bonded.

On the other hand, a substrate using a glass material has begun to be studied from the viewpoint of heat resistance, rigidity, a degree of integration of transmission lines for telecommunication, cost, and the like.

For example, Patent Literature 1 discloses that an optical waveguide can be formed by performing ion exchange of Na ions in glass for Ag ions.
Patent Literature 1: JP2021-511538A
Patent Literature 2: JP7059993B

### SUMMARY OF INVENTION

A technique for performing ion exchange of ions in glass for other ions has been known as a technique for mainly increasing the strength of the glass, as shown in, for example, Patent Literature 2.

With respect to this, as a result of studies conducted by the inventors of the present invention, it has been found that it is difficult to obtain a stable optical waveguide that realizes control of a core thickness and high homogeneity even when the optical waveguide is formed by using the ion exchange technique in the related art as described above. In particular, it is difficult to form an optical waveguide that can cope with light propagated in a single mode.

In addition, in Patent Literature 1, in order to make the Ag—Na IOX (ion exchange) region serving as a core region a buried-type structure, in addition to ion exchange in which Na ions are exchanged for Ag ions, reverse ion exchange in which Ag ions are exchanged for Na ions again is performed. However, in the case where the core region is formed by the ion exchange and the reverse ion exchange, it is difficult to form the core region with a sufficiently large refractive index at a position deep from the surface of the optical waveguide substrate.

On the other hand, an optical waveguide substrate used for the Co-Packaged Optics (CPO) technology that has attracted attention in recent years is required to have a core region with a large refractive index difference relative to the cladding region, located deep below the substrate surface.

Therefore, an object of the present invention is to provide an optical waveguide substrate capable of forming a core region even at a deep position from a substrate surface, and an optical device including the optical waveguide substrate.

As a result of studies conducted by the inventors of the present invention to cope with the above problems, it has been found that, even in the case where the core region is formed by performing ion exchange, the above problems can be solved by forming the cladding region located around the core region with two or more different materials, and the present invention has been completed.

That is, the present invention relates to the following [1] to [13].
[1] An optical waveguide substrate containing:
a cladding layer A; and
a cladding layer B bonded to the cladding layer A,
in which the cladding layer A contains a glass having a cladding region A and a core region having a refractive index higher than that of the cladding region A,
in which the glass constituting the cladding region A contains, in terms of mol % on an oxide basis, 5% or more of Na₂O,
in which the glass constituting the core region contains Na₂O and Ag₂O and has a lower content ratio of Na₂O and a higher content ratio of Ag₂O than the glass constituting the cladding region A,
in which the core region is located in a region including a part of a surface of the cladding layer A on the cladding layer B side, and
in which the cladding layer B contains a cladding region B having a refractive index lower than that of the core region of the cladding layer A.
[2] The optical waveguide substrate according to [1],
in which the cladding layer B contains a glass layer or a resin layer, and
in which the cladding layer A is directly bonded to the glass layer or the resin layer.
[3] The optical waveguide substrate according to [1],
in which the cladding layer B contains an adhesive layer and a glass layer or a resin layer,
in which the adhesive layer has a thickness of less than 5 μm,
in which the cladding region B contains the adhesive layer and the glass layer or the resin layer, and
in which the cladding layer A and the cladding layer B are bonded via the adhesive layer.
[4] The optical waveguide substrate according to [1],
in which the cladding layer B contains an adhesive layer and a glass layer or a resin layer,
in which the adhesive layer has a thickness of 5 μm or more,
in which the cladding region B contains the adhesive layer, and
in which the cladding layer A and the cladding layer B are bonded via the adhesive layer.
[5] The optical waveguide substrate according to [3],
in which a refractive index difference between the adhesive layer constituting the cladding region B and the glass constituting the cladding region A is 0.1 or less.
[6] The optical waveguide substrate according to [4],
in which a refractive index difference between the adhesive layer constituting the cladding region B and the glass constituting the cladding region A is 0 to 0.003, and
in which the adhesive layer has a thickness of 5 μm to 100 μm.
[7] The optical waveguide substrate according to any one of [1] to [6],
in which a material constituting the cladding region B has a dielectric loss tangent of 0.01 or less at 10 GHz.
[8] The optical waveguide substrate according to any one of [1] to [7],
in which a material constituting the cladding region B has a thermal expansion coefficient of 5×10⁻⁷/K to 120×10⁻⁷/K.
[9] The optical waveguide substrate according to [3] or [5],
in which the cladding layer B contains the adhesive layer and the glass layer, and
in which the glass constituting the cladding region B has a lower content ratio of Na₂O than the glass constituting the cladding region A.
[10] The optical waveguide substrate according to any one of [1] to [9],
in which the glass constituting the cladding region A satisfies, in terms of mol % based on oxides:
   SiO₂: 45% to 80%,
   Al₂O₃: 0% to 15%,
   B₂O₃: 0% to 20%,
   MgO, CaO, SrO, and BaO: 10% to 30% in total, and
   Na₂O: 5% to 25%.
[11] The optical waveguide substrate according to any one of [1] to [10],
in which the cladding layer B contains an adhesive layer and a glass layer,
in which the adhesive layer has a thickness of 5 μm or more,
in which the cladding region B contains the adhesive layer, and
in which the glass constituting the glass layer of the cladding layer B satisfies, in terms of mol % based on oxides:
   SiO₂: 57% to 70%,
   Al₂O₃: 5% to 15%,
   B₂O₃: 15% to 24%,
   MgO: 0.1% to 10%,
   CaO: 0.1% to 10%,
   SrO: 0.1% to 10%,
   BaO: 0% to 10%, and
   ZnO: 0% to 0.1%.
[12] The optical waveguide substrate according to any one of [1] to [11],
in which a difference between the maximum value of a refractive index in the core region and a refractive index in the cladding region A is from 0.003 to 0.06 in the cladding layer A.
[13] An optical device comprising:
the optical waveguide substrate according to any one of [1] to [12]; and
an optical coupler that extracts at least a part of light transmitted by the optical waveguide substrate to the outside.

The optical waveguide substrate according to the present invention can form the core region even at a deep position from the substrate surface. Therefore, it can be suitably applied to the Co-Packaged Optics (CPO) technology.

### BRIEF DESCRIPTION OF DRAWINGS

FIG. 1 is a schematic cross-sectional view illustrating one aspect of the optical waveguide substrate 10 according to the present embodiment.

FIG. 2 is a schematic cross-sectional view illustrating one aspect of the optical waveguide substrate 10′ according to the present embodiment.

FIG. 3 is a schematic cross-sectional view illustrating one aspect of the optical waveguide substrate 10″ according to the present embodiment.

FIG. 4 is a schematic cross-sectional view illustrating one aspect of the optical waveguide substrate 10′″ according to the present embodiment.

### DESCRIPTION OF EMBODIMENTS

Hereinafter, the present invention is described in detail, but the present invention is not limited to the following embodiments and can be freely modified and implemented without departing from the gist of the present invention. In addition, the symbol “-” or the word “to” that is used to express a numerical range includes the numerical values before and after the symbol or the word as the lower limit value and the upper limit value of the range, respectively.

In the present description, parts by mass has the same meaning as parts by weight, and mass % has the same meaning as weight %.

### <<Optical Waveguide Substrate>

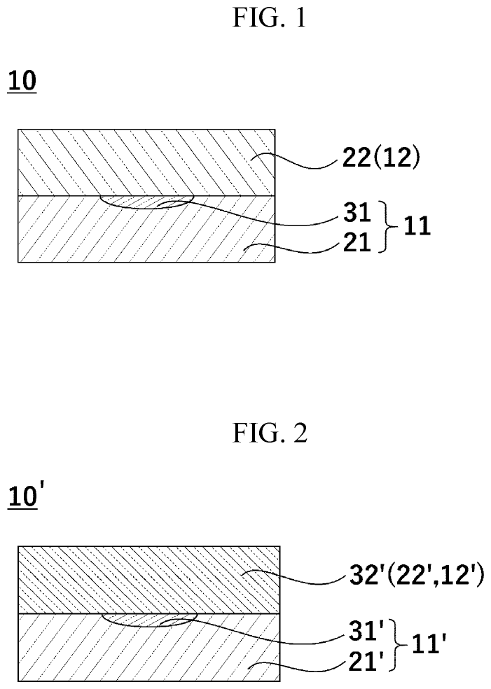

As illustrated in FIG. 1, the optical waveguide substrate 10 according to the present embodiment includes a cladding layer A (11) and a cladding layer B (12) joined to the cladding layer A (11).

The cladding layer A (11) is made of glass having a cladding region A (21) and a core region (31), and the core region (31) has a higher refractive index than the cladding region A (21).

Specifically, the glass constituting the cladding region A (21) in the cladding layer A (11) contains Na₂O in an amount of 5% or more in terms of mol % based on oxides. The glass constituting the core region (31) in the cladding layer A (11) contains Na₂O and Ag₂O, and has a lower content ratio of Na₂O and a higher content ratio of Ag₂O than the glass constituting the cladding region A (21). The core region (31) is located in a region including a part of the surface of the cladding layer A (11) on the cladding layer B (12) side.

The cladding layer B (12) has a cladding region B (22), and the refractive index of the cladding region B (22) is lower than the refractive index of the core region (31) of the cladding layer A (11).

As a more specific aspect of the optical waveguide substrate 10′ according to the present embodiment, as illustrated in FIG. 2, the cladding layer B (12′) is formed of a glass layer or resin layer (32′), and the cladding layer A (11′) and the glass layer or resin layer (32′) forming the cladding layer B (12′) are directly bonded to each other to form an optical waveguide.

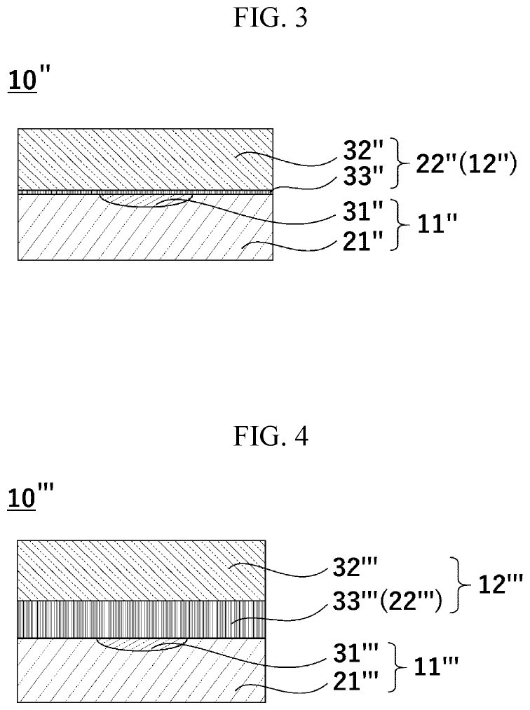

As another specific aspect of the optical waveguide substrate 10″ according to the present embodiment, as illustrated in FIG. 3, the cladding layer B (12″) is formed of an adhesive layer (33″) and a glass layer or resin layer (32″), and the thickness of the adhesive layer (33″) is less than 5 μm. In this case, the cladding region B (22″) in the cladding layer B (12″) is formed of the adhesive layer (33″) and the glass layer or resin layer (32″).

The cladding layer A (11″) and the cladding layer B (12″) are bonded to each other via the adhesive layer (33″) of the cladding layer B (12″) to form an optical waveguide.

As another specific aspect of the optical waveguide substrate 10′″ according to the present embodiment, as illustrated in FIG. 4, the cladding layer B (12′″) is formed of an adhesive layer (33′″) and a glass layer or resin layer (32″), and the thickness of the adhesive layer (33″) is 5 μm or more. In this case, the cladding region B (22′″) in the cladding layer B (12′″) is formed of the adhesive layer (33′″), and the refractive index of the glass layer or resin layer (32′″) is not particularly limited. That is, the refractive index of the glass layer or resin layer (32′″) may be larger or smaller than, or equal to the refractive index of the core region (31′″) of the cladding layer A (11′″).

The cladding layer A (11′″) and the cladding layer B (12′″) are bonded to each other via the adhesive layer (33′″) of the cladding layer B (12′″) to form an optical waveguide.

Next, each configuration of the optical waveguide substrate will be described.

### <Cladding Layer A>

The cladding layer A (11) in the present embodiment is made of glass having a cladding region A (21) and a core region (31).

### Cladding Region A

The refractive index of the cladding region A (21) in the present embodiment is lower than the refractive index of the core region (31).

Since the core region (31) in the cladding layer A (11) is generally formed by performing ion exchange on a partial region of the cladding layer A (11), the composition of the glass constituting the cladding region A (21) coincides with the composition of the base glass constituting the cladding layer A (11).

That is, in the present description, the base composition of the glass constituting the cladding layer A can be regarded as the same as the composition of the glass constituting the cladding layer A before performing the ion exchange treatment, and the composition of the portion deeper than the ion exchange depth (DOL) in the ion-exchanged region can be regarded as the same as the base composition of the glass constituting the cladding layer A except for the case where an extreme ion exchange treatment is performed. That is, the composition at the plate thickness center of the glass constituting the cladding layer A and the composition of the glass constituting the cladding region A usually match the base composition of the glass constituting the cladding layer A.

The glass constituting the cladding region A (21) in the present embodiment contains Na₂O in an amount of 5% or more in terms of mol % based on oxides, and the content of Na₂O is preferably 5% to 25%, more preferably 6% to 22.5%, still more preferably 7% to 20%, still more preferably 8% to 17.5%, and particularly preferably 9% to 16%. Na₂O is a component that imparts a high refractive index to the core portion by undergoing ion exchange for Ag ions, thereby enabling it to be an optical waveguide, and improves meltability of the glass. From the above viewpoints, the content of Na₂O is preferably 5% or more, more preferably 6% or more, still more preferably 7% or more, even more preferably 8% or more, and particularly preferably 9% or more. On the other hand, the content of Na₂O is preferably 25% or less, more preferably 22.5% or less, still more preferably 20% or less, even more preferably 17.5% or less, and particularly preferably 16% or less, from the viewpoint of improving water resistance of the glass.

Examples of the glass constituting the cladding region A (21) in the present embodiment include silicate glass and aluminosilicate glass.

For example, it is preferable that the glass, in terms of molar percentage based on oxides, in addition to containing Na₂O in an amount of 5% or more, contains other components whose contents satisfy 45% to 80% of SiO₂ and 0% to 15% of Al₂O₃. It is also preferable to satisfy 45% to 80% of SiO₂ and 10% to 30% of MgO, CaO, SrO, and BaO in total. It is more preferable to satisfy 45% to 80% of SiO₂, 0% to 15% of Al₂O₃, and 10% to 30% of MgO, CaO, SrO, and BaO in total. It is more preferable to further satisfy 5% to 25% of Na₂O.

More specifically, the glass constituting the cladding region A (21) in the present embodiment preferably satisfies the following composition range in terms of mol % based on oxides.
45% to 80% of SiO₂,
0% to 15% of Al₂O₃,
0% to 20% of B₂O₃,
10% to 30% of MgO, CaO, SrO, and BaO in total, and
5% to 25% of Na₂O

Components other than Na₂O of the glass constituting the cladding region A (21) in the present embodiment will also be described below. The expression “%” is a molar percentage based on oxides.

The content of SiO₂ is preferably 40% to 80%, more preferably 45% to 80%, still more preferably 45% to 75%, even more preferably 50% to 70%, even still more preferably 52.5% to 67.5%, and particularly preferably 55% to 65%. The content of SiO₂ is preferably 40% or more, more preferably 45% or more, still more preferably 50% or more, even more preferably 52.5% or more, and particularly preferably 55% or more, from the viewpoint of forming a glass network and improving chemical durability. The content of SiO₂ is preferably 80% or less, more preferably 75% or less, still more preferably 70% or less, even more preferably 67.5% or less, and particularly preferably 65% or less, from the viewpoint of meltability.

The content of Al₂O₃ is preferably 0% to 15%, more preferably 1% to 12.5%, still more preferably 1.5% to 10%, even more preferably 2% to 8%, and particularly preferably 2.5% to 7.5%. Al₂O₃ does not need to be contained, but from the viewpoint of increasing the ion exchange rate and improving productivity, the content of Al₂O₃ is preferably 1% or more, more preferably 1.5% or more, still more preferably 2% or more, and even more preferably 2.5% or more. The content of Al₂O₃ is preferably 15% or less, more preferably 12.5% or less, still more preferably 10% or less, even more preferably 8% or less, and particularly preferably 7.5% or less, from the viewpoint of reducing the ion exchange rate from Na ions in the glass to Ag ions, realizing the desired core thickness for the core region (31), and forming a core region (31) having high homogeneity.

The content of B₂O₃ is preferably 0% to 20%, more preferably 2% to 17.5%, still more preferably 4% to 15%, even more preferably 6% to 12.5%, and particularly preferably 8% to 11%. B₂O₃ does not need to be contained, but from the viewpoint of improving meltability, the content of B₂O₃ is preferably 2% or more, more preferably 4% or more, still more preferably 6% or more, and even more preferably 8% or more. On the other hand, the content of B₂O₃ is preferably 20% or less, more preferably 17.5% or less, still more preferably 15% or less, even more preferably 12.5% or less, and particularly preferably 11% or less, from the viewpoint of preventing occurrence of striae during melting and deterioration of the quality of the optical waveguide substrate. In order to improve acid resistance, it is preferable not to contain B₂O₃.

The total content of the alkaline earth metal oxides represented by the total of MgO, CaO, SrO, and BaO is preferably 10% to 30%, more preferably 11% to 27.5%, still more preferably 12% to 25%, even more preferably 13% to 22.5%, and particularly preferably 14% to 20%. The total content is preferably 10% or more, more preferably 11% or more, still more preferably 12% or more, even more preferably 13% or more, and particularly preferably 14% or more, from the viewpoint of reducing the ion exchange rate from Na ions in the glass to Ag ions, realizing the desired core thickness for the core region (31), and forming a core region (31) having high homogeneity. The total content is preferably 30% or less, more preferably 27.5% or less, still more preferably 25% or less, even more preferably 22.5% or less, and particularly preferably 20% or less, from the viewpoint of improving productivity of producing an optical waveguide by increasing the ion exchange rate to some extent.

The content of MgO is preferably 0% to 20%, more preferably 1% to 18%, still more preferably 2% to 16%, even more preferably 3% to 14%, and particularly preferably 4% to 12%. MgO does not need to be contained, but from the viewpoint of improving meltability of the glass and controlling the ion exchange rate, the content of MgO is preferably 1% or more, more preferably 2% or more, still more preferably 3% or more, and particularly preferably 4% or more. The content of MgO is preferably 20% or less, more preferably 18% or less, still more preferably 16% or less, even more preferably 14% or less, and particularly preferably 12% or less, from the viewpoint of preventing devitrification during melting.

The content of CaO is preferably 0% to 20%, more preferably 1% to 18%, still more preferably 2% to 16%, even more preferably 3% to 14%, even still more preferably 4% to 12%, and particularly preferably 4.5% to 12%. CaO does not need to be contained, but from the viewpoint of improving meltability of the glass and controlling the ion exchange rate, the content of CaO is preferably 1% or more, more preferably 2% or more, still more preferably 3% or more, even still more preferably 4% or more, and particularly preferably 4.5% or more. The content of CaO is preferably 20% or less, more preferably 18% or less, still more preferably 16% or less, even more preferably 14% or less, and particularly preferably 12% or less, from the viewpoint of preventing devitrification during melting.

The content of SrO is preferably 0% to 20%, more preferably 1% to 18%, still more preferably 2% to 16%, even more preferably 3% to 14%, even still more preferably 4% to 12%, and particularly preferably 4.5% to 12%. SrO does not need to be contained, but from the viewpoint of improving meltability of the glass and controlling the ion exchange rate, the content of SrO is preferably 1% or more, more preferably 2% or more, still more preferably 3% or more, even still more preferably 4% or more, and particularly preferably 4.5% or more. The content of SrO is preferably 20% or less, more preferably 18% or less, still more preferably 16% or less, even more preferably 14% or less, and particularly preferably 12% or less, from the viewpoint of preventing devitrification during melting.

The content of BaO is preferably 0% to 20%, more preferably 1% to 18%, still more preferably 2% to 16%, even more preferably 3% to 14%, even still more preferably 4% to 12%, and particularly preferably 4.5% to 12%. BaO does not need to be contained, but from the viewpoint of improving meltability of the glass and controlling the ion exchange rate, the content of BaO is preferably 1% or more, more preferably 2% or more, still more preferably 3% or more, even still more preferably 4% or more, and particularly preferably 4.5% or more. The content of BaO is preferably 20% or less, more preferably 18% or less, still more preferably 16% or less, even more preferably 14% or less, and particularly preferably 12% or less, from the viewpoint of preventing devitrification during melting.

The content of Li₂O is preferably 0% to 10%, more preferably 0.1% to 5%, still more preferably 0.3% to 4%, even more preferably 0.4% to 3%, and particularly preferably 0.5% to 2.5%. Li₂O does not need to be contained, but from the viewpoint of improving meltability, the content of Li₂O is preferably 0.1% or more, more preferably 0.3% or more, still more preferably 0.4% or more, and particularly preferably 0.5% or more. On the other hand, from the viewpoint of increasing Δn which is the difference between the maximum value Nmax of the refractive index of the cladding layer A (11) and the refractive index N of the cladding region A (21) described later, the content of Li₂O is preferably 10% or less, more preferably 5% or less, further preferably 4% or less, further preferably 3% or less, and particularly preferably 2.5% or less.

The content of K₂O is preferably 0% to 10%, more preferably 0.1% to 5%, still more preferably 0.3% to 4%, even more preferably 0.4% to 3%, and particularly preferably 0.5% to 2.5%. K₂O does not need to be contained, but from the viewpoint of improving meltability, the content of K₂O is preferably 0.1% or more, more preferably 0.3% or more, still more preferably 0.4% or more, and still more preferably 0.5% or more. On the other hand, from the viewpoint of increasing the refractive index difference between the core region (31) and the cladding region A (21), the content of K₂O is preferably 10% or less, more preferably 5% or less, further preferably 4% or less more, preferably 3% or less, still more preferably 2.5% or less.

The content of P₂O₅ is preferably 0% to 4%, more preferably 0.5% to 3%, and still more preferably 1% to 2%. P₂O₅ does not need to be contained, but from the viewpoint of ion exchange performance and chipping resistance, the content of P₂O₅ is preferably 0.5% or more, more preferably 1% or more, and still more preferably 2% or more. On the other hand, the content of P₂O₅ is preferably 4% or less, more preferably 3% or less, still more preferably 2% or less, and even more preferably 1% or less, from the viewpoint of crushability and acid resistance. From the viewpoint of acid resistance, it is preferable that P₂O₅ is substantially not contained.

Note that, “substantially not contained” in the present description means that the component is not contained other than inevitable impurities contained in a raw material or the like, that is, the component is not intentionally contained. Specifically, it means that the content in the glass composition is less than 0.1 mol %.

The content of ZnO is preferably 0% to 10%, more preferably 0.25% to 7%, still more preferably 0.25% to 5%, even more preferably 0.5% to 2%, and particularly preferably 0.5% to 1%. ZnO does not need to be contained, but from the viewpoint of meltability, the content of ZnO is preferably 0.25% or more and more preferably 0.5% or more. On the other hand, the content of ZnO is preferably 10% or less, more preferably 7% or less, still more preferably 5% or less, even more preferably 2% or less, and particularly preferably 1% or less, from the viewpoint of weather resistance.

The content of TiO₂ is preferably 0% to 1%, more preferably 0.1% to 0.5%, still more preferably 0.15% to 0.5%, and even more preferably 0.2% to 0.25%. TiO₂ does not need to be contained, but from the viewpoint of crushability, the content of TiO₂ is preferably 0.1% or more, more preferably 0.15% or more, and still more preferably 0.2% or more. On the other hand, the content of TiO₂ is preferably 1% or less, more preferably 0.5% or less, and still more preferably 0.25% or less, from the viewpoint of preventing deterioration of the quality due to devitrification.

The content of ZrO₂ is preferably 0% to 8%, more preferably 0.5% to 6%, still more preferably 0.5% to 4%, even more preferably 1% to 2%, and particularly preferably 1% to 1.2%. ZrO₂ does not need to be contained, but from the viewpoint of improving weather resistance, the content of ZrO₂ is preferably 0.5% or more, and more preferably 1% or more. On the other hand, the content of ZrO₂ is preferably 8% or less, more preferably 6% or less, still more preferably 4% or less, even more preferably 2% or less, and particularly preferably 1.2% or less, from the viewpoint of preventing deterioration of the quality due to devitrification.

The content of each of Y₂O₃, La₂O₃, and Nb₂O₅ is preferably 0% to 8%, more preferably 0.5% to 6%, still more preferably 1% to 5%, even more preferably 1.5% to 4%, even still more preferably 2% to 3%, and particularly preferably 2.5% to 3%. Y₂O₃, La₂O₃, and Nb₂O₅ do not need to be contained, but from the viewpoint of improving weather resistance, the content of each of Y₂O₃, La₂O₃, and Nb₂O₅ is preferably 0.5% or more, more preferably 1% or more, still more preferably 1.5% or more, even more preferably 2% or more, and particularly preferably 2.5% or more. On the other hand, the content of each of Y₂O₃, La₂O₃, and Nb₂O₅ is preferably 8% or less, more preferably 6% or less, still more preferably 5% or less, even more preferably 4% or less, and particularly preferably 3% or less, from the viewpoint of preventing deterioration of the quality due to devitrification.

The content of each of Ta₂O₅ and Gd₂O₃ is preferably 0% to 1%, and more preferably 0% to 0.5%. Ta₂O₅ and Gd₂O₃ do not need to be contained, but may be contained in a small amount from the viewpoint of improving weather resistance. On the other hand, the content of each of Ta₂O₅ and Gd₂O₃ is preferably 1% or less and more preferably 0.5% or less, and it is still more preferable that Ta₂O₅ and Gd₂O₃ are substantially not contained, from the viewpoint of the refractive index and reflectance.

In the case of coloring the glass for use, a coloring component may be added within a range that does not inhibit the desired effect. Examples of the coloring component include Co₃O₄, MnO₂, Fe₂O₃, NiO, CuO, Cr₂O₃, V₂O₅, Bi₂O₃, SeO₂, TiO₂, CeO₂, Er₂O₃, and Nd₂O₃.

The total content of the coloring component is preferably 0% to 7%, more preferably 0% to 5%, still more preferably 0% to 3%, and even more preferably 0% to 1%. The total content of the coloring component is preferably 7% or less, more preferably 5% or less, still more preferably 3% or less, and even more preferably 1% or less, and it is particularly preferable that the coloring component is substantially not contained, from the viewpoint of preventing devitrification.

In addition, in the case where the coloring component is added, it is preferable that absorption at a wavelength to be used does not occur. Specifically, the absorption coefficient in the wavelength region of 1300 nm to 1600 nm is preferably less than 1 cm⁻¹, more preferably less than 0.5 cm⁻¹, and particularly preferably less than 0.1 cm⁻¹. The absorption coefficient is usually 0.0001 cm⁻¹ or more.

SO₃, a chloride, and a fluoride may be appropriately contained as a fining agent during melting of the glass.

As₂O₃ is preferably substantially not contained. In the case where Sb₂O₃ is contained, the content thereof is preferably 0.3% or less and more preferably 0.1% or less, and it is still more preferable that Sb₂O₃ is substantially not contained.

Ag₂O may be contained from the viewpoint of improving ion exchangeability, but is set lower than the content ratio of Ag₂O in the glass constituting the core region (31). Since Ag₂O is a component used to increase the refractive index of the core region (31), even in the case where Ag₂O is contained, the content of Ag₂O in the cladding region A (21) is preferably less than 0.01%, more preferably 0.005% or less, and still more preferably 0.001% or less. From the viewpoint of increasing the refractive index of the core region (31), it is more preferable that Ag₂O is substantially not contained. Note that, “Ag₂O is substantially not contained” means less than a detection limit value of a device.

The refractive index in the cladding region A (21) is not particularly limited as long as it is lower than the refractive index in the core region (31).

However, since the core region (31) is formed by ion exchange, the refractive index of the cladding region A (21) is high in a region near the boundary with the core region (31) and is not constant. Therefore, in the present embodiment, the refractive index of the cladding region A (21) refers to the refractive index of glass having the same composition as the base composition of the glass before ion exchange, that is, the base glass. In the case of the cladding layer A (11) in the present embodiment, the refractive index of the cladding region A (21) sufficiently separated from the core region (31) is the same as the refractive index of the base composition. Therefore, although different depending on the thickness of the cladding layer A (11), for example, the refractive index of glass at the plate thickness center of the cladding layer A (11) may be used as the refractive index of the cladding region A (21).

In consideration of the refractive index of the base composition of the glass usually used for an optical waveguide, the refractive index in the cladding region A (21) is, for example, preferably 1.50 to 1.59, more preferably 1.51 to 1.58, still more preferably 1.52 to 1.57, even more preferably 1.525 to 1.56, and particularly preferably 1.53 to 1.555. Here, the refractive index in the cladding region A (21) is preferably 1.50 or more, more preferably 1.51 or more, still more preferably 1.52 or more, even more preferably 1.525 or more, and particularly preferably 1.53 or more, from the viewpoint of matching the refractive index with that of a silicon semiconductor and reducing loss due to bonding. The refractive index is preferably 1.59 or less, more preferably 1.58 or less, still more preferably 1.57 or less, even more preferably 1.56 or less, and particularly preferably 1.555 or less, from the viewpoint of receiving light from an optical fiber such as SiO₂.

The refractive index in the present description is a refractive index for light having a wavelength of 589 nm.

### Core Region

The core region (31) of the cladding layer A (11) in the present embodiment is a region serving as an optical waveguide, and is formed by ion exchange of Na ions in glass for Ag ions. Therefore, the glass constituting the core region (31) contains Na₂O and Ag₂O, and has a lower content ratio of Na₂O and a higher content ratio of Ag₂O than the glass constituting the cladding region A (21). Thus, the refractive index of the core region (31) becomes higher than the refractive index of the cladding region A (21). Since the ion exchange is performed in a part of the surface of the cladding layer A (11), the core region (31) is usually located in a region including a part of the surface of the cladding layer A (11).

However, since the core region (31) in the present embodiment is formed by ion exchange, the concentrations of Na₂O and Ag₂O in the core region (31) are not constant, and a distribution also occurs in the refractive index. Therefore, the boundary between the core region (31) and the cladding region A (21) is determined as follows.

First, the maximum value of the refractive index of the cladding layer A (11) in a cross-sectional view perpendicular to the path of the optical waveguide, which is the core region (31), is denoted as Nmax. The refractive index of the cladding region A (21) described above is denoted as N. The difference (Nmax−N) between the maximum value Nmax of the refractive index and the refractive index N of the cladding region A (21) is defined as Δn, and a region in which the refractive index is greater than or equal to the value represented by {N+(Δn/2)} is defined as the core region (31). That is, the region of the cladding layer A (11) outside the core region (31) defined above becomes the cladding region A (21).

Since the core region (31) in the present embodiment is formed in a part of the surface of the cladding layer A (11), the composition of the glass constituting the core region (31) has the same content of components excluding Na₂O and Ag₂O involved in ion exchange, and the preferred range is also the same.

The Na₂O content in the glass constituting core region (31) may be lower than the Na₂O content in the glass constituting cladding region A (21).

The specific content of Na₂O in the core region (31) varies depending on the content of Na₂O in the cladding region A (21) and cannot be defined unconditionally; however, it is, for example, preferably 0 to 20%, more preferably 1 to 17.5%, still more preferably 2 to 15%, even more preferably 3 to 12.5%, and particularly preferably 4 to 10%. The content of Na₂O in the core region (31) is preferably 0% or more, more preferably 1% or more, still more preferably 2% or more, even more preferably 3% or more, and particularly preferably 4% or more, from the viewpoint of meltability of the glass. On the other hand, the content of Na₂O is preferably 20% or less, more preferably 17.5% or less, still more preferably 15% or less, even more preferably 12.5% or less, and particularly preferably 10% or less, from the viewpoint of preventing the difference in refractive index between the core region (31) and the cladding region A (21) from becoming too large and preventing the single-mode light from not propagating.

The difference in Na₂O content between the glass constituting the core region (31) and the glass constituting the cladding region A (21) has a relationship with the ion exchange amount between Na ions and Ag ions, and it is preferably 1% to 15%, more preferably 1.5% to 14%, still more preferably 2% to 13%, even more preferably 2.5% to 12%, and particularly preferably 3% to 11%. The difference in Na₂O content is preferably 1% or more, more preferably 1.5% or more, still more preferably 2% or more, even more preferably 2.5% or more, and particularly preferably 3% or more, from the viewpoint of increasing the refractive index of the core region (31) by ion exchange for Ag ions and more suitably coping with single-mode light propagation as an optical waveguide even in the case where the thickness of the core region (31) is small. On the other hand, the difference in Na₂O content is preferably 15% or less, more preferably 14% or less, still more preferably 13% or less, even more preferably 12% or less, and particularly preferably 11% or less, from the viewpoint of preventing a core diameter required for single-mode light propagation from being extremely narrow due to the refractive index difference between the core region (31) and the cladding region A (21) being too large.

The content of Ag₂O in the glass constituting the core region (31) is, for example, preferably 0.01% or more, more preferably 0.01% to 10%, still more preferably 0.5% to 8%, even more preferably 1% to 6%, and particularly preferably 1.5% to 5%. The content of Ag₂O is preferably 0.01% or more, more preferably 0.5% or more, still more preferably 1% or more, and even more preferably 1.5% or more, from the viewpoint of increasing the refractive index of the core region (31). On the other hand, in the case where the difference in refractive index between the core region (31) and the cladding region A (21) is too large, it is necessary to reduce the core diameter, so that the content of Ag₂O is preferably 10% or less, more preferably 8% or less, further preferably 6% or less, and particularly preferably 5% or less.

The refractive index in the core region (31) is not particularly limited as long as it is higher than the refractive index in the cladding region A (21). However, as described above, since the core region (31) in the present embodiment is formed by ion exchange, the concentration of Ag₂O in the core region (31) is not constant, and a distribution also occurs in the refractive index.

Therefore, in the present embodiment, the maximum value Nmax of the refractive index is used as an index of the refractive index in the core region (31). In consideration of the refractive index of the base composition of the glass usually used for an optical waveguide, the maximum value Nmax of the refractive index is, for example, preferably 1.50 to 2.0, more preferably 1.51 to 1.9, still more preferably 1.52 to 1.8, even more preferably 1.525 to 1.7, and particularly preferably 1.53 to 1.6. Here, the Nmax is preferably 1.50 or more, more preferably 1.51 or more, still more preferably 1.52 or more, even more preferably 1.525 or more, and particularly preferably 1.53 or more, from the viewpoint of reducing loss due to bonding to a silicon semiconductor. The Nmax is preferably 2.0 or less, more preferably 1.9 or less, still more preferably 1.8 or less, even more preferably 1.7 or less, and particularly preferably 1.6 or less, from the viewpoint of reducing loss due to bonding to an optical fiber formed of SiO₂ or the like.

The difference Δn between the maximum value Nmax of the refractive index in the core region (31) and the refractive index N in the cladding region A (21) is, for example, preferably 0.003 to 0.06, more preferably 0.005 to 0.05, and still more preferably 0.005 to 0.04, and may be 0.007 to 0.03, 0.01 to 0.02, or 0.012 to 0.018. Here, the Δn is preferably 0.003 or more and more preferably 0.005 or more, and may be 0.007 or more, 0.01 or more, or 0.012 or more, from the viewpoint of controlling, for example, bending the incident light. The upper limit of the Δn is not particularly limited, and the refractive index difference that can be caused by ion exchange is usually 0.06 or less and preferably 0.05 or less, and may be 0.04 or less, 0.03 or less, 0.02 or less, or 0.018 or less.

The propagation loss amount of light having a wavelength of 1200 nm to 1600 nm in the core region (31) is preferably 3.0 dB/cm or less, more preferably 2.0 dB/cm or less, still more preferably 1.0 dB/cm or less, even more preferably 0.5 dB/cm or less, and particularly preferably 0.2 dB/cm or less at maximum. The lower limit is not particularly limited since the propagation loss amount of the light is preferably as small as possible, and is usually 0.001 dB/cm or more.

The thickness of the core region (31) in the thickness direction of the cladding layer A (11) is preferably 1.8 μm to 10 μm, more preferably 2 μm to 9 μm, and may be 3 μm to 8 μm, 4 μm to 7 μm, 4.25 μm to 6 μm, or 4.5 μm to 5.5 μm. The thickness may be 3 μm to 8 μm, 3 μm to 7 μm, 3 μm to 6 μm, or 3 μm to 5.5 μm. Here, as the thickness of the core region (31) decrease, it is necessary to increase the refractive index difference between the core region (31) and the cladding region A (21), but in this case, the mode-field diameter changes with a slight change in refractive index, and it is difficult to strictly control the core thickness. In addition, in the case where an optical waveguide has a bent region, it is difficult to confine light. From the above viewpoint, the thickness is preferably 1.8 μm or more, more preferably 2 μm or more, and may be 3 μm or more, 4 μm or more, 4.25 μm or more, or 4.5 μm or more. In the case where an optical waveguide has a path containing a bent region, the thickness described above is preferably 10 μm or less, more preferably 9 μm or less, and may be 8 μm or less, 7 μm or less, 6 μm or less, or 5.5 μm or less, from the viewpoint of preventing a bending loss.

The core region (31) may have a fan shape including a semicircular shape in a cross-sectional view perpendicular to the path of the optical waveguide, and is preferably a semicircular shape. The “fan shape” is formed by two radii and an arc between the radii, and a shape in which the arc portion is positioned on a lower side in the vertical direction in the same cross-sectional view is preferred.

In the case where the core region (31) has a fan shape in the same cross-sectional view, the Ag concentration is high in a region close to the intersection point of the two radii, and the Ag concentration decreases as the distance from the intersection point increases.

### Cladding Layer A (11)

The cladding layer A (11) in the present embodiment is made of glass having the cladding region A (21) and the core region (31).

The thickness of the cladding layer A (11) varies depending on the thickness of the cladding layer B (12) and the device to be mounted, but is, for example, preferably 100 μm to 3000 μm, more preferably 200 μm to 2000 μm, and still more preferably 400 μm to 1000 μm. Here, from the viewpoint of rigidity, the thickness is preferably 100 μm or more, more preferably 200 μm or more, and still more preferably 400 μm or more. In addition, from the viewpoint of reducing the height of the electronic member, the thickness is preferably 3000 μm or less, more preferably 2000 μm or less, and still more preferably 1000 μm or less.

### <Cladding Layer B>

The cladding layer B (12) in the present embodiment is joined to the cladding layer A (11) and has a cladding region B (22). The refractive index of the cladding region B (22) is lower than the refractive index of the core region (31) in the cladding layer A (11).

The cladding layer B (12) may be formed of a glass layer or resin layer (32), or may be formed of a glass layer or resin layer (32) and an adhesive layer (33).

In the case where the cladding layer B (12) is formed of the glass layer or resin layer (32), the cladding region B (22) is formed of the glass layer or resin layer (32).

In the case where the cladding layer B (12) is composed of the glass layer or resin layer (32) and the adhesive layer (33), the cladding region B (22) is composed of the glass layer or resin layer (32) and the adhesive layer (33) when the thickness of the adhesive layer (33) is less than 5 μm. In the case where the thickness of the adhesive layer is 5 μm or more, the cladding region B (22) is formed of the adhesive layer (33).

### Cladding Region B

As illustrated in FIG. 2, an aspect of the cladding region B (22′) in the present embodiment includes a glass layer or resin layer (32′), and the cladding layer A (11′) and the glass layer or resin layer (32′) are directly bonded to each other. Thus, the glass layer or resin layer (32′) covers the periphery of the core region (31′) together with the cladding region A (21′) to form an optical waveguide. Therefore, the refractive index of the glass layer or resin layer (32′) in this case is lower than the refractive index of the core region (31′).

In the case where the cladding layer B (12′) is formed of the cladding region B (22′) formed of the glass layer or resin layer (32′), the difference Δn′ between the refractive index N′ of the glass layer or resin layer (32′) and the maximum value Nmax of the refractive index in the core region (31′) is, for example, preferably 0.003 to 0.06, more preferably 0.005 to 0.05, still more preferably 0.005 to 0.04, and may be 0.007 to 0.03, 0.01 to 0.02 or 0.012 to 0.018. Here, the Δn′ is preferably 0.003 or more, more preferably 0.005 or more, and may be 0.007 or more, 0.01 or more, or 0.012 or more, from the viewpoint of controlling, for example, bending the incident light. The upper limit of the Δn′ is not particularly limited, and the refractive index difference that can be caused by ion exchange is usually 0.06 or less, preferably 0.05 or less, and may be preferably 0.04 or less, 0.03 or less, 0.02 or less, or 0.018 or less.

As illustrated in FIG. 3, another aspect of the cladding region B (22″) in the present embodiment includes an adhesive layer (33″) having a thickness of less than 5 μm and a glass layer or resin layer (32″). The cladding layer A (11″) and the cladding layer B (12″) are bonded via an adhesive layer (33″).

In the case where the cladding layer B (12″) is composed of the cladding region B (22″) composed of the adhesive layer (33″) and the glass layer or resin layer (32″), the difference Δn″ between the refractive index N″ of the adhesive layer (33″) and the maximum value Nmax of the refractive index in the core region (31″) is, for example, preferably 0.003 to 0.06, more preferably 0.005 to 0.05, still more preferably 0.005 to 0.04, and may be 0.007 to 0.03, 0.01 to 0.02 or 0.012 to 0.018. Here, the Δn″ is preferably 0.003 or more, more preferably 0.005 or more, and may be 0.007 or more, 0.01 or more, or 0.012 or more, from the viewpoint of controlling, for example, bending the incident light. The upper limit of the Δn″ is not particularly limited, and the refractive index difference that can be caused by ion exchange is usually 0.06 or less, preferably 0.05 or less, and may be 0.04 or less, 0.03 or less, 0.02 or less, or 0.018 or less.

The difference Δn′″ between the refractive index N′″ of the glass layer or resin layer (32″) constituting the cladding region B (22″) and the maximum value Nmax of the refractive index in the core region (31″) is, for example, preferably 0.003 to 0.06, more preferably 0.005 to 0.05, still more preferably 0.005 to 0.04, and may be 0.007 to 0.03, 0.01 to 0.02 or 0.012 to 0.018. Here, the Δn′″ is preferably 0.003 or more, more preferably 0.005 or more, and may be 0.007 or more, 0.01 or more, or 0.012 or more, from the viewpoint of controlling, for example, bending the incident light. The upper limit of the Δn′″ is not particularly limited, and the refractive index difference that can be caused by ion exchange is usually 0.06 or less, preferably 0.05 or less, and may be 0.04 or less, 0.03 or less, 0.02 or less, or 0.018 or less.

Another aspect of the cladding region B (22′″) in the present embodiment is a case where the thickness of the adhesive layer (33′″) is 5 μm or more, and as illustrated in FIG. 4, the cladding region B (22′″) is formed of the adhesive layer (33′″). The cladding layer A (11′″) and the cladding layer B (12′″) are bonded via the adhesive layer (33′″).

In the case where the cladding layer B (12′″) is formed of the cladding region B (22′″) formed of the adhesive layer (33′″), the difference Δn″″ between the refractive index N″″ of the adhesive layer (33′″) and the maximum value Nmax of the refractive index in the core region (31′″) is, for example, preferably 0.003 to 0.06, more preferably 0.005 to 0.05, still more preferably 0.005 to 0.04, and may be 0.007 to 0.03, 0.01 to 0.02 or 0.012 to 0.018. Here, the Δn″″ is preferably 0.003 or more, more preferably 0.005 or more, and may be 0.007 or more, 0.01 or more, or 0.012 or more, from the viewpoint of controlling, for example, bending the incident light. The upper limit of the Δn″″ is not particularly limited, and the refractive index difference that can be caused by ion exchange is usually 0.06 or less, preferably 0.05 or less, and may be 0.04 or less, 0.03 or less, 0.02 or less, or 0.018 or less.

In this case, since the glass layer or resin layer (32′″) of the cladding layer B (12′″) is not involved in the configuration of the optical waveguide, the refractive index is arbitrary and can be selected according to desired characteristics.

The dielectric loss tangent at 10 GHz of the material constituting the cladding region B (22) in the present embodiment is preferably 0.01 or less, more preferably 0.005 or less, and still more preferably 0.003 or less, from the viewpoint that the optical waveguide substrate plays a role as a circuit that transmits not only light but also an electric signal. The dielectric loss tangent is preferably as small as possible, but is usually 0.0001 or more.

Here, in the case where the cladding region B (22) is composed of the adhesive layer (33″) and the glass layer or resin layer (32″), the dielectric loss tangent of both the adhesive layer (33″) and the glass layer or resin layer (32″) is preferably within the above range.

In the case where the cladding region B (22) is composed of only the adhesive layer (33′″), the dielectric loss tangent of the adhesive layer (33′″) is preferably within the above range. On the other hand, from the viewpoint that the optical waveguide substrate also serves as a circuit, the dielectric loss tangent of the glass layer or resin layer (32′″) is preferably within the above range.

The thermal expansion coefficient of the material constituting the cladding region B (22) in the present embodiment is preferably 5×10⁻⁷/K to 120×10⁻⁷/K, more preferably 10×10⁻⁷/K to 120×10⁻⁷/K, still more preferably 20×10⁻⁷/K to 80×10⁻⁷/K, and even more preferably 30×10⁻⁷/K to 60×10⁻⁷/K. Here, from the viewpoint of suppressing thermal warpage when connected to silicon, the thermal expansion coefficient is preferably 5×10⁻⁷/K or more, more preferably 10×10⁻⁷/K or more, still preferably 20×10⁻⁷/K or more, and even preferably 30×10⁻⁷/K or more. From the same viewpoint, the thermal expansion coefficient is preferably 120×10⁻⁷/K or less, more preferably 80×10⁻⁷/K or less, and still more preferably 60×10⁻⁷/K or less.

In the present description, the thermal expansion coefficient means an average thermal expansion coefficient at 50 °C to 350 °C.

In the case where the cladding region B (22) is composed of only the adhesive layer (33′″), the thermal expansion coefficient of the adhesive layer (33′″) is preferably within the above range.

In the case where the cladding region B (22) is composed of the adhesive layer (33″) and the glass layer or resin layer (32″), the thermal expansion coefficients of both the adhesive layer (33″) and the glass layer or resin layer (32″) are preferably within the above range.

The cladding region B (22) in the present embodiment is joined to the cladding region A (21). In the case where the cladding region B (22) is formed of a glass layer, the composition of the glass constituting the glass layer may be the same as or different from the composition of the glass constituting the cladding region A (21).

That is, in the present embodiment, in the case where the cladding region A (21) and the cladding region B (22) are made of glass having the same composition, an aspect in which one glass plate is partially subjected to ion exchange at a certain depth, and a part of the periphery of the core region formed by the ion exchange is regarded as the cladding layer A (11) and the other part of the periphery is regarded as the cladding layer B (12) is excluded.

On the other hand, an aspect in which the cladding layer A (11) is prepared, the cladding layer B (12) made of glass having the same composition as the glass constituting the cladding region A (21) of the cladding layer A (11) is prepared, and these layers are bonded is included in the optical waveguide substrate according to the present embodiment.

The fact that the cladding layer A (11) and the cladding layer B (12) are bonded to each other as described above, means that there is a bonding surface at the boundary between both layers. The presence of the bonding surface can be confirmed by, for example, microscopic observation or composition analysis.

However, in the optical waveguide substrate according to the present embodiment, it is not essential to use glass having good ion exchangeability for the cladding layer B (12), and in view of the fact that it is preferable that the cladding layer B (12) can be formed of glass or resin having desired characteristics, the composition of the glass constituting the glass layer of the cladding region B (22) is preferably different from the composition of the glass constituting the cladding region A (21). It is also preferable that the cladding region B (22) is formed of a resin layer.

### Adhesive Layer

The thickness of the adhesive layer (33) in the present embodiment determines whether or not the glass layer or resin layer (32) in the cladding layer B (12) constitutes the cladding region B (22).

In the case where the thickness of the adhesive layer (33) is less than 5 μm, the thickness of the adhesive layer (33″) is preferably 0.1 μm or more and less than 5 μm, more preferably 0.5 μm to 3 μm, still more preferably 0.8 μm to 2 μm, and still more preferably 1 μm to 2 μm. Here, from the viewpoint of adhesiveness between the cladding layer A (11″) and the cladding layer B (12″), the thickness is preferably 0.1 μm or more, more preferably 0.5 μm or more, further preferably 0.8 μm or more, and still further preferably 1 μm or more. In addition, from the viewpoint of hardly affecting the propagation state of light, the thickness is less than 5 μm, preferably 3 μm or less, and more preferably 2 μm or less.

In this case, the refractive index difference between the adhesive layer (33″) and the glass constituting the cladding region A (21″) in the cladding layer A (11″) is preferably smaller than the refractive index difference between the core region (31″) and the cladding region A (21″) from the viewpoint of confining light in the core region (31″) of the cladding layer A (11″). The refractive index difference between the adhesive layer (33″) and the glass constituting the cladding region A (21″) in the cladding layer A (11″) is preferably 0.1 or less. In addition, the refractive index difference described above is preferably 0.1 or less, more preferably 0.02 or less, and still more preferably 0.01 or less. The lower limit of the refractive index difference is not particularly limited and may be 0, that is, the refractive indices of the adhesive layer (33″) and the glass constituting the cladding region A (21″) may be the same. The refractive index difference may be, for example, 0.0005 or more.

Either the refractive index of the adhesive layer (33″) or the refractive index of the cladding region A (21″) may be higher.

In the case where the thickness of the adhesive layer (33) is 5 μm or more, the thickness of the adhesive layer (33′″) is preferably 5 μm to 100 μm, more preferably 8 μm to 80 μm, and still more preferably 10 μm to 60 μm. Here, from the viewpoint that the adhesive layer (33′″) suitably constitutes the optical waveguide as the cladding region B (22′″) together with the cladding region A (21′″) and the core region (31′″), the thickness is 5 μm or more, preferably 8 μm or more, and more preferably 10 μm or more. From the viewpoint of heat resistance, the thickness described above is preferably 100 μm or less, more preferably 80 μm or less, and still more preferably 60 μm or less.

In this case, the refractive index difference between the adhesive layer (33′″) and the glass constituting the cladding region A (21′″) in the cladding layer A (11″) is preferably 0 to 0.003, more preferably 0 to 0.002, and still more preferably 0.0001 to 0.001. Here, the refractive index difference is preferably 0.003 or less, more preferably 0.002 or less, and still more preferably 0.001 or less from the viewpoint of confining light in the core region (31′″) of the cladding layer A (11′″). The lower limit of the refractive index difference is not particularly limited and may be 0, that is, the refractive indices of the adhesive layer (33′″) and the glass constituting the cladding region A (21′″) may be the same. The refractive index difference may be, for example, 0.0001 or more.

Either the refractive index of the adhesive layer (33′″) or the refractive index of the cladding region A (21′″) may be higher.

The adhesive layer (33) is not particularly limited as long as it can bond the cladding layer A (11) and the cladding layer B (12) and has the above-described desired physical properties.

The material constituting the adhesive layer (33) may include, for example, at least one resin or curing agent, selected from the group consisting of an acrylic resin, an epoxy resin, a urethane resin, a silicone resin, an enethiol resin, a polyimide resin, a fluororesin, a photocurable agent, and a thermosetting agent.

Among these, from the viewpoint of heat resistance, an acrylic resin, a fluororesin, a silicone resin, a polyimide resin, or a resin composition containing these resins as a main component and further containing a photocurable agent or a thermosetting agent is preferable. Here, the main component in the resin composition means a component having the largest content among components constituting the resin composition.

### Glass Layer or Resin Layer

The presence or absence of the adhesive layer (33) and the thickness thereof determine whether or not the glass layer or resin layer (32) in the present embodiment forms the cladding region B (22) in the cladding layer B (12).

In the case where the adhesive layer (33) does not exist, as illustrated in FIG. 2, the glass layer or resin layer (32′) serves as the cladding region B (22′) constituting the cladding layer B (12′).

In the case where the thickness of the adhesive layer (33) is less than 5 μm, as illustrated in FIG. 3, the glass layer or resin layer (32″) serves as a cladding region B (22′) constituting the cladding layer B (12′) together with the adhesive layer (33″).

In the case where the thickness of the adhesive layer (33) is 5 μm or more, as illustrated in FIG. 4, the adhesive layer (33′″) serves as the cladding region B (22′″), and thus any glass layer or resin layer (32′″) can be adopted.

### Glass Layer

In the case where the glass layer or resin layer (32) constituting the cladding layer B (12) is a glass layer and the glass layer does not constitute the cladding region B (22), that is, in the case where the thickness of the adhesive layer (33) is 5 μm or more, any glass can be adopted as the glass constituting the glass layer.

That is, for example, glass having a small dielectric loss tangent is preferably used as the glass. It is also preferable to use glass having a thermal expansion coefficient of 5×10⁻⁷/K to 120×10⁻⁷/K.

Further, the glass constituting the cladding region A (21) needs to contain Na₂O in an amount of 5% or more in order to form the core region (31) by ion exchange for Ag ions, whereas it is optional whether the glass of the glass layer constituting the cladding layer B (12) contains Na₂O or not.

Therefore, from the viewpoint of reducing the dielectric loss tangent, the glass in the glass layer preferably has a lower content ratio of Na₂O than in the glass constituting the cladding region A (21) of the cladding layer A (11).

Examples of the glass in the glass layer that does not constitute the cladding region B (22) include borosilicate glass and silica glass.

For example, the glass preferably satisfies SiO₂ of 57% to 70% and B₂O₃ 15% to 24% in molar percentage based on oxides. It is also preferable to satisfy SiO₂ of 57% to 70% and Al₂O₃ 5% to 15%.

More specifically, the glass not constituting the cladding region B (22) in the present embodiment preferably satisfies the following composition range in terms of mol % based on oxides:
SiO₂ 57% to 70%,
Al₂O₃ 5% to 15%,
B₂O₃ 15% to 24%,
MgO 0.1% to 10%,
CaO 0.1% to 10%,
SrO 0.1% to 10%,
BaO 0% to 10%, and
ZnO 0% to 0.1%.

Each component of the glass not constituting the cladding region B (22) in the present embodiment will be described below. The expression “%” is a molar percentage based on oxides.

SiO₂ is a network-forming substance. The content of SiO₂ is preferably 57% to 70%, more preferably 58% to 68%, still more preferably 60% to 66%, and even more preferably 61% to 65%. Here, from the viewpoint of improving glass-forming ability and weather resistance and suppressing devitrification, the content is preferably 57% or more, more preferably 58% or more, further preferably 60% or more, and still further preferably 61% or more. The content is preferably 70% or less, more preferably 68% or less, still more preferably 66% or less, even more preferably 65% or less, yet still more preferably 64% or less, and particularly preferably 63% or less, in the viewpoint of solubility.

Al₂O₃ is a component that is effective in improving weather resistance, increasing a Young's modulus, preventing phase separation of the glass, decreasing a coefficient of thermal expansion, and the like. The content of Al₂O₃ is preferably 5% to 15%, more preferably 6% to 14%, still more preferably 7% to 13%, and even more preferably 8% to 12%. Here, the content is preferably 5% or more, more preferably 6% or more, still more preferably 7% or more, and even more preferably 8% or more, from the viewpoint of achieving the effect of containing Al₂O₃. The content described above is preferably 15% or less, more preferably 14% or less, still more preferably 13% or less, and even more preferably 12% or less from the viewpoint of solubility and the like.

B₂O₃ is a component that improves solubility. The content of B₂O₃ is preferably 15% to 24%, more preferably 16% to 23%, still more preferably 17% to 22%, and even more preferably 17.5% to 21%. Here, from the viewpoint of solubility and the viewpoint of reducing dielectric loss tangent in a high-frequency region, the content is preferably 15% or more, more preferably 16% or more, further preferably 17% or more, and still further preferably 17.5% or more. The content described above is preferably 24% or less, more preferably 23% or less, still more preferably 22% or less, even more preferably 21% or less, even still more preferably 20% or less, yet still more preferably 19% or less, and most preferably 18% or less from the viewpoint of chemical resistance.

MgO is a component that increases the Young's modulus without increasing the specific gravity. That is, MgO is a component that increases the specific elastic modulus, which can reduce a deflection problem, increase a fracture toughness value, and improve strength of the glass. In addition, MgO is also a component that improves solubility.

The content of MgO is preferably 0.1% to 10%, more preferably 0.2% to 9%, still more preferably 1% to 8%, and even more preferably 2% to 7%. Here, from the viewpoint of suitably obtaining the effect of containing MgO and suppressing the thermal expansion coefficient from becoming too low, the content is preferably 0.1% or more, more preferably 0.2% or more, still more preferably 1% or more, and still more preferably 2% or more. In addition, the content is preferably 10% or less, more preferably 9% or less, still more preferably 8% or less, even more preferably 7% or less, even still more preferably 6% or less, yet more preferably 5% or less, particularly preferably 4% or less, and most preferably 3% or less, from the viewpoint of preventing an increase in the devitrification temperature.

CaO is a component that has a characteristic of increasing the specific elastic modulus next to MgO among alkaline earth metals and not excessively lowering strain point, and improves solubility similarly to MgO. Further, CaO is also a component having a characteristic that the devitrification temperature is less likely to be increased as compared with MgO.

The content of CaO is preferably 0.1% to 10%, more preferably 0.2% to 8%, still more preferably 0.5% to 7%, even more preferably 1% to 6%, and particularly preferably 2% to 5%. The content is preferably 0.1% or more, more preferably 0.2% or more, still more preferably 0.5% or more, even more preferably 1% or more, and particularly preferably 2% or more, from the viewpoint of sufficiently achieving the effect of containing CaO. The content is preferably 10% or less, more preferably 8% or less, still more preferably 7% or less, even more preferably 6% or less, even still more preferably 5% or less, and yet still more preferably 4% or less, and most preferably 3% or less, from the viewpoint of not excessively increasing the average thermal expansion coefficient and preventing an increase in the devitrification temperature to suppress devitrification during glass production.

SrO is a component that does not increase the devitrification temperature of the glass and improves solubility. The content of SrO is preferably 0.1% to 10%, more preferably 0.2% to 9%, still more preferably 0.5% to 8%, even more preferably 1% to 7%, and particularly preferably 2% to 6%. The content is preferably 0.1% or more, more preferably 0.2% or more, still more preferably 0.5% or more, even more preferably 1% or more, and particularly preferably 2% or more, from the viewpoint of sufficiently achieving the effect of containing SrO. In addition, from the viewpoint of preventing the average thermal expansion coefficient from becoming too high without excessively increasing the specific gravity, the content is preferably 10% or less, more preferably 9% or less, still more preferably 8% or less, still more preferably 7% or less, still more preferably 6% or less, still more preferably 5% or less, still more preferably 4% or less, particularly preferably 3% or less, and most preferably 2.5% or less.

BaO is a component that does not increase the devitrification temperature of the glass and improves solubility. The content of BaO is preferably 0% to 10%, more preferably 0.1% to 8%, still more preferably 0.2% to 5%, even more preferably 1% to 5%, and particularly preferably 2% to 3%. Here, in the case where BaO is contained, from the viewpoint of sufficiently obtaining the effect of BaO, the content is preferably 0.1% or more, more preferably 0.2% or more, still more preferably 1% or more, and particularly preferably 2% or more. In addition, from the viewpoint that the specific gravity does not become too large and the view point of the Young's modulus, relative dielectric constant, average thermal expansion coefficient, and the like, the content is preferably 10% or less, more preferably 8% or less, still more preferably 5% or less, and still more preferably 3% or less.

ZnO is a component that improves chemical resistance, while it is a component that easily causes phase separation and increases the devitrification temperature. The content of ZnO is preferably 0% to 0.1%. The content is preferably 0.1% or less, more preferably 0.05% or less, still more preferably 0.03% or less, and even more preferably 0.01% or less, and it is particularly preferable that ZnO is substantially not contained. Note that, “ZnO is substantially not contained” means, for example, less than 0.01%.

In addition to the above, other components may be contained in accordance with desired characteristics as glass not constituting the cladding region B (22). Examples of other components include alkali metal oxides such as Li₂O, Na₂O, and K₂O, and Se₂O₃, CdO, BeO, Sc₂O₃, TiO₂, ZnO₂, Ga₂O₃, GeO₂, Y₂O₃, ZrO₂, Nb₂O₅, In₂O₃, TeO₂, HfO₂, Ta₂O₅, WO₃, Bi₂O₃, La₂O₃, Gd₂O₃, Yb₂O₃, Lu₂O₃, SnO₂, Cl, SO₃.

In the case where the glass layer or resin layer (32) constituting the cladding layer B (12) is a glass layer and the glass layer constitutes the cladding region B (22), that is, in the case where the thickness of the adhesive layer (33) is less than 5 μm, the refractive index of the glass constituting the glass layer is lower than the refractive index of the core region (31) of the cladding layer A (11). Thus, the cladding region B (22) including the glass layer can form an optical waveguide together with the core region (31) and the cladding region A (21).

The specific composition of the glass of the glass layer constituting the cladding region B (22) is not particularly limited as long as the refractive index thereof is lower than the refractive index of the core region (31) as described above.

Examples of the glass include aluminoborosilicate glass and silica glass.

A specific composition may be, for example, the same as the composition used for the cladding region A (21) of the cladding layer A (11). The same composition as the composition used for the glass in the case where the glass layer does not constitute the cladding region B (22) may be used as long as the refractive index is low.

### Resin Layer

In the case where the glass layer or resin layer (32) constituting the cladding layer B (12) is a resin layer and the resin layer does not constitute the cladding region B (22), that is, in the case where the thickness of the adhesive layer (33) is 5 μm or more, any resin can be adopted as the resin constituting the resin layer.

That is, for example, a resin having a small dielectric loss tangent is preferably used as the resin. It is also preferable to use a resin having a thermal expansion coefficient of 5×10⁻⁷/K to 150×10⁻⁷/K.

As such a resin layer not constituting the cladding region B (22), for example, a resin layer containing at least one resin or curing agent selected from the group consisting of an acrylic resin, an epoxy resin, a urethane resin, a silicone resin, an enethiol resin, a polyimide resin, a fluororesin, a photocurable agent, and a thermosetting agent can be adopted.

More specifically, from the viewpoint of heat resistance, the resin layer preferably contains an acrylic resin, a fluororesin, a silicone resin, a polyimide resin, or a resin composition containing these resins as a main component and further containing a photocurable agent or a thermosetting agent. Here, the main component in the resin composition means a component having the largest content among components constituting the resin composition.

In the case where the glass layer or resin layer (32) constituting the cladding layer B (12) is a resin layer and the resin layer constitutes the cladding region B (22), that is, in the case where the thickness of the adhesive layer (33) is less than 5 μm, the refractive index of the resin constituting the resin layer is lower than the refractive index of the core region (31) of the cladding layer A (11). Thus, the cladding region B (22) including the resin layer can form an optical waveguide together with the core region (31) and the cladding region A (21).

The specific composition of the resin of the resin layer constituting the cladding region B (22) is not particularly limited as long as the refractive index thereof is lower than the refractive index of the core region (31) as described above.

For example, the material constituting the resin layer may contain at least one resin or curing agent selected from the group consisting of an acrylic resin, an epoxy resin, a urethane resin, a silicone resin, an enethiol resin, a polyimide resin, a fluororesin, a photocurable agent, and a thermosetting agent. More specifically, for example, from the viewpoint of heat resistance, an acrylic resin, a fluororesin, a silicone resin, a polyimide resin, or a resin composition containing these resins as a main component and further containing a photocurable agent or a thermosetting agent is preferable. Here, the main component in the resin composition means a component having the largest content among components constituting the resin composition.

### Cladding Layer B (12)

The cladding layer B (12) in the present embodiment has the cladding region B (22).

The thickness of the cladding layer B (12) varies depending on the thickness of the cladding layer A (11) and the device to be mounted, but is, for example, preferably 10 μm to 3000 μm, more preferably 20 μm to 2000 μm, and still more preferably 30 μm to 1000 μm. The thickness is preferably 10 μm or more, more preferably 20 μm or more, and still more preferably 30 μm or more, from the viewpoint of confining light in the core region of the cladding layer A. In addition, from the viewpoint of reducing the height of the electronic member, the thickness is preferably 3000 μm or less, more preferably 2000 μm or less, and still more preferably 1000 μm or less.

In the case where the cladding layer B (12) includes only the cladding region B (22), the preferable thickness of the cladding region B (22) is the same as the preferable thickness of the cladding layer B (12).

On the other hand, in the case where the cladding layer B (12) includes the glass layer or resin layer (32) in addition to the cladding region B (22), the thickness of the cladding region B (22) is, for example, preferably 100 μm to 5000 μm, more preferably 200 μm to 4000 μm, and still more preferably 300 μm to 3000 μm. Here, from the viewpoint of rigidity, the thickness is preferably 100 μm or more, more preferably 200 μm or more, and still more preferably 300 μm or more. In addition, from the viewpoint of reducing the height of the electronic member, the thickness is preferably 5000 μm or less, more preferably 4000 μm or less, and still more preferably 3000 μm or less.

### <Optical Waveguide Substrate>

The thickness of the optical waveguide substrate according to the present embodiment varies depending on the device to be mounted, and is, for example, preferably 0.1 mm to 4.0 mm (100 μm to 4000 μm), more preferably 0.15 mm to 2.0 mm, still more preferably 0.2 mm to 1.5 mm, even more preferably 0.25 mm to 1.0 mm, and particularly preferably 0.3 mm to 0.8 mm. Here, the thickness of the optical waveguide substrate is preferably 0.1 mm or more, more preferably 0.15 mm or more, still more preferably 0.2 mm or more, even more preferably 0.25 mm or more, and particularly preferably 0.3 mm or more, from the viewpoint of ease of handling of members. On the other hand, the thickness of the optical waveguide substrate is preferably 4.0 mm or less, more preferably 2.0 mm or less, still more preferably 1.5 mm or less, even more preferably 1.0 mm or less, and particularly preferably 0.8 mm or less, from the viewpoint of reducing the height of electronic members.

The optical waveguide substrate according to the present embodiment is preferably used in an optical device. That is, the optical device according to the present embodiment preferably includes the optical waveguide substrate and an optical coupler that extracts at least a part of light transmitted by the optical waveguide substrate to the outside.

The optical waveguide substrate according to the present embodiment can be mounted on, for example, an optical integrated device. In an aspect of the optical integrated device, the optical waveguide substrate is connected to a semi-conductor substrate, and light propagated in a single mode is introduced into the semi-conductor substrate through the core portion of the optical waveguide substrate. The semi-conductor substrate is preferably, for example, a silicon semiconductor substrate.

The optical waveguide substrate according to the present embodiment is not limited to the above-described aspect, and may be mounted on a pluggable device.

The optical waveguide substrate according to the present embodiment can be applied not only to an optical transmission line as described above but also to a position such as an interposer.

### <<Method of Manufacturing Optical Waveguide Substrate>>

### <Method for Producing Cladding Layer A>

The method for producing the cladding layer A in the present embodiment is not particularly limited, but includes, for example, the following steps:
(i) a step of preparing a glass plate containing Na₂O, and
(ii) a step of bringing a region of the glass plate, which is to be a core region of an optical waveguide, into contact with a molten salt containing Ag ions to ion-exchange Na ions in the glass with the Ag ions.

In the step (i), a glass may be produced or a commercially available glass may be used as it is.

In the case of producing a glass, a known method can be used. For example, raw materials of components of the glass are blended, and then heated and melted in a glass-melting furnace. Thereafter, the glass is homogenized by a known method and shaped into a desired shape, followed by annealing, to thereby obtain a glass plate.

In the ion exchange step of the step (ii), when a partial region of one surface of the glass plate is subjected to ion exchange and Na ions in the glass are ion-exchanged with Ag ions, the refractive index of the ion-exchanged region becomes higher than that of a region not subjected to ion exchange. That is, the core region can be formed by the ion exchange.

In order to stably form the core region in which the ion exchange depth is controlled, it is important that the ion exchange rate from Na ions to Ag ions is not too fast.

For example, in the case where the ion exchange rate is such that the thickness of the core region becomes 2.5 μm to 10 μm by the ion exchange treatment for 20 minutes or more, the ion exchange depth can be appropriately controlled, and homogeneity of the core region is maintained, which is preferable. From the viewpoint of productivity, the time of the ion exchange treatment is preferably 6 hours or shorter.

It is preferable to reduce the content of the A1 component as the base composition of the glass substrate, that is, the composition of the glass of the cladding region A, in order to appropriately perform ion exchange from Na ions to Ag ions in the treatment time as described above. Further, while the alkaline earth metal component is a component that increases the ion exchange rate from Na ions to Ag ions, the ion exchange rate conversely decreases by containing a certain amount or more of the alkaline earth metal component.

As one aspect of the ion exchange step, in the case of performing the ion exchange by immersing the glass plate in a molten salt, it is preferable to mask a portion other than the region to be an optical waveguide.

The masking may be any masking as long as it does not react with the molten salt or inhibits ion exchange between a component constituting the glass and a component of the molten salt even in contact with the molten salt. For example, the masking is performed by using Al₂O₃, SiO₂, SiN, TiO₂, ITO, or the like.

The masking may be appropriately adjusted according to the desired thickness of the core region or the maximum width in the horizontal direction in a cross-sectional view perpendicular to the desired optical waveguide path. For example, the width of the gap for forming the core region is preferably 1 μm to 12 μm, more preferably 2 μm to 11 μm, and still more preferably 3 μm to 10 μm. The width is preferably 1 μm or more, more preferably 2 μm or more, and still more preferably 3 μm or more, from the viewpoint of improving the effect of confining light. On the other hand, the width is preferably 12 μm or less, more preferably 11 μm or less, and still more preferably 10 μm or less, from the viewpoint of transmitting light in a single mode.

The method of bringing the masked glass plate into contact with the molten salt containing Ag ions is not particularly limited, and examples thereof include immersion of the glass plate in the molten salt, application of the molten salt, and spraying of the molten salt. Among them, immersion in the molten salt is preferred from the viewpoint of allowing a treatment at a high temperature for a long time.

The molten salt is any as long as it contains Ag ions, and examples of a salt containing Ag ions include AgNO₃, Ag₂SO₄, Ag₂CO₃, and AgCl. Among them, AgNO₃ is preferred from the viewpoint of melting temperature. The salt containing Ag ions may be used alone or in combination of plural kinds thereof.

In order to adjust the concentration of Ag ions in the molten salt, it is preferable to use a mixed molten salt obtained by mixing the salt containing Ag ions with another salt.

Examples of other salts include a nitrate, a sulfate, a carbonate, and a chloride. Among them, examples of the nitrate include lithium nitrate, sodium nitrate, potassium nitrate, and cesium nitrate. Examples of the sulfate include lithium sulfate, sodium sulfate, potassium sulfate, and cesium sulfate. Examples of the carbonate include lithium carbonate, sodium carbonate, and potassium carbonate. Examples of the chloride include lithium chloride, sodium chloride, potassium chloride, and cesium chloride.

Among them, sodium nitrate, sodium sulfate, sodium carbonate, and sodium chloride are preferably contained, and sodium nitrate and sodium sulfate are more preferred, from the viewpoint of preventing an unnecessary stress from being applied to the glass.

The above salts may be used alone or in combination of plural kinds thereof.

The content ratio of Ag ions with respect to the total amount of cations in the molten salt is preferably 0.5% to 20%, more preferably 1.0% to 19%, still more preferably 1.5% to 18%, even more preferably 2.0% to 17%, and particularly preferably 2.5% to 16% in terms of mass ratio. The content of Ag ions is preferably 0.5% or more, more preferably 1.0% or more, still more preferably 1.5% or more, even more preferably 2.0% or more, and particularly preferably 2.5% or more, from the viewpoint of increasing the refractive index difference. On the other hand, the content of Ag ions is preferably 20% or less, more preferably 19% or less, still more preferably 18% or less, even more preferably 17% or less, and particularly preferably 16% or less, from the viewpoint that the control of the core diameter becomes too delicate when the refractive index is too large.

The temperature of the molten salt is not particularly limited as long as it is equal to or higher than the melting point of the salt, and it is, for example, preferably 250 °C to 490 °C, more preferably 280 °C to 450 °C, still more preferably 300 °C to 430 °C, even more preferably 325 °C to 410 °C, and particularly preferably 350 °C to 400 °C. The temperature of the molten salt is preferably 250 °C or higher, more preferably 280 °C or higher, still more preferably 300 °C or higher, even more preferably 325 °C or higher, and particularly preferably 350 °C or higher, from the viewpoint of productivity. On the other hand, the temperature of the molten salt is preferably 490 °C or lower, more preferably 450 °C or lower, still more preferably 430 °C or lower, even more preferably 410 °C or lower, and particularly preferably 400 °C or lower, from the viewpoint of realizing the desired core region thickness with higher homogeneity.

The time of contact with the molten salt varies depending on the contact method, and the immersion time in the case of immersing the glass plate in the molten salt is preferably 20 minutes to 6 hours, more preferably 30 minutes to 4 hours, still more preferably 35 minutes to 3 hours, even more preferably 40 minutes to 2.5 hours, and particularly preferably 45 minutes to 2 hours. Here, the immersion time is preferably 20 minutes or longer, more preferably 30 minutes or longer, still more preferably 35 minutes or longer, even more preferably 40 minutes or longer, and particularly preferably 45 minutes or longer, from the viewpoint of realizing the desired core region thickness with higher homogeneity. On the other hand, the immersion time is preferably 6 hours or shorter, more preferably 4 hours or shorter, still more preferably 3 hours or shorter, even more preferably 2.5 hours or shorter, and particularly preferably 2 hours or shorter, from the viewpoint of productivity.

In performing the step (ii), the glass plate may be preheated. The preheating temperature varies depending on the temperature of the molten salt, and it is preferably, for example, 100 °C or higher.

After the step (ii), a washing step or a drying step may be performed.

In the washing step, the glass is washed by using industrial water, ion exchange water, or the like. As the industrial water, water treated as necessary is used. Among them, ion exchange water is preferred.

The washing condition varies depending on a washing liquid to be used, and in the case of using ion exchange water, washing at 0 °C to 100 °C is preferred from the viewpoint of completely removing adhering salts.

In the washing step, use can be made of various methods such as a method of immersing a glass plate in a water tank containing ion exchange water or the like, a method of exposing the surface of a glass plate to flowing water, and a method of spraying a washing liquid toward the surface of a glass plate by a shower.

### <Method for Producing Cladding Layer B>

The method of manufacturing the cladding layer B in the present embodiment is not particularly limited, and the manufacturing method may be appropriately selected according to the aspect of the cladding layer B.

In FIG. 2, in the case where the cladding layer B (12′) is formed of a glass layer and the cladding layer A (11′) and the glass layer are directly bonded to each other, for example, a method of preparing the glass layer in advance and bonding the cladding layer A (11′) and the glass layer to each other by thermocompression bonding or by activating the surface thereof by plasma treatment, may be used.

In FIG. 2, in the case where the cladding layer B (12′) is formed of a resin layer and the cladding layer A (11′) and the resin layer are directly bonded to each other, for example, a method of selecting a thermosetting resin or a photocurable resin as the resin layer, preparing a precursor that is a pre-cured resin layer in advance, placing the precursor on the cladding layer A (11′), and curing the precursor by heating or light irradiation to form the resin layer, thereby achieving the bonding, may be used. In the case where the resin layer is a thermoplastic resin, the resin layer may be prepared in advance and the resin layer is bonded to the cladding layer A (11′) by thermocompression bonding by heating.

As illustrated in FIG. 3, in the case where the cladding layer B (12″) is composed of the glass layer or resin layer (32″) and the adhesive layer (33″), the cladding layer A (11″) and the cladding layer B (12″) are bonded via the adhesive layer (33″).

At this time, the adhesive layer (33″) may be applied onto the surface of the cladding layer A (11″), and the glass layer or resin layer (32″) may be placed thereon for bonding, or the adhesive layer (33″) bonded to the glass layer or resin layer (32″) in advance may be bonded to the cladding layer A (11″).

As a method of bonding the cladding layer A (11′″) and the cladding layer B (12′″) in the aspect illustrated in FIG. 4, the same method as the bonding method in the aspect illustrated in FIG. 3 can be adopted.

The glass layer or resin layer (32) and the adhesive layer (33) constituting the cladding layer B (12) can be formed by conventionally known methods.

### EXAMPLES

Hereinafter, the present invention is described based on specific Examples. The present invention is not limited to the following Examples.

### <<Cladding Layer: G1 to G18 and G′1 to G′21>>

Glass raw materials were weighed and mixed so as to have the composition shown in Tables 1 and 4 in molar percentage in terms of oxides and have a glass weight of 400 g. The mixed raw materials were charged into a platinum crucible, melted in an electric furnace at 1500 °C to 1700 °C for about 3 hours, defoamed, and homogenized. The “-” column in the tables means that the component is not intentionally added.

The molten glass obtained above was poured into a metal mold and held at a temperature about 10 °C higher than the glass transition temperature for 1 hour. Next, the temperature was reduced to room temperature at a rate of 0.5 °C/min to obtain a glass block.

The obtained glass block was cut, ground, and finally mirror-polished on both sides to obtain the respective glass plates G1 to G18 and G′1 to G′21 each being 20 mm×20 mm×0.7 mm.

The glass plates of G1 to G18 may be used as they are as the cladding layer B or as the cladding layer A. In the case of being used as the cladding layer A, the core region is formed by subsequently performing an ion exchange treatment. The glass plates of G′1 to G′21 are used as the cladding layer B as they are.

### <<Core Region of Cladding Layer A: A1 to A42>>

The glass plates of G1 to G18 shown in Table 1 or 2, obtained above were subjected to an ion exchange treatment under the conditions shown in Tables 5 to 7 to produce A1 to A42 to be the core regions of the cladding layer A.

In the ion exchange treatment, a mixed molten salt of AgNO₃ and NaNO₃ was used as the Ag-containing salt. The proportions (mass %) of Ag and Na in the mixed molten salt were as described in “Ag salt” in Tables 5 to 7. The glass plate preheated to 200 °C was immersed in the molten salt of each of the Ag-containing salts. The temperature and the immersion time of the molten salt are as described in “Temp. 1 (°C)” and “Hold time 1 (hr)” in Tables 5 to 7.

A30 to A42 were subjected to the ion exchange treatment described above, and then immersed in the NaNO₃ molten salt to perform another ion exchange between Ag in the glass and Na. The temperature and the immersion time of the molten salt are as described in “Temp. 2 (°C)” and “Hold time 2 (hr)” in Table 7.

Regarding the core region of the cladding layer A after the ion exchange treatment, obtained above, the distribution of ions was measured from the surface of the glass plate to a depth of 100 μm by an electron probe microanalyzer method. The amount of Ag and the amount of Na at the point where the amount of Ag ions is the maximum in the glass can be regarded as the Ag₂O content and the Na₂O content in the glass constituting the core region in the optical waveguide, respectively, and are shown in “[Ag] (core region) (mol %)” and “[Na] (core region) (mol %)” in Tables 5 to 7, respectively. Other elements such as Si were not described since the composition thereof did not change from that of the glass before the ion exchange treatment, that is, the glass of G1 to G18 that are the cladding region A.

In addition, in all of A1 to A42, since ion exchange was performed on the glass plates of G1 to G18 without masking, the periphery of the core region is not entirely covered with the cladding region. However, the change amount that is the difference between the refractive index of the base glass before the ion exchange and the maximum value of the refractive index after the ion exchange can be regarded as the same as those in the case where the ion exchange is performed with masking to form the core region serving as an optical waveguide. Further, the difference between the refractive index after the ion exchange and the refractive index of the cladding region B in the cladding layer B can be regarded as the same as the difference in the refractive index in the case where the masking is performed and the ion exchange is performed under the same conditions to form the core region serving as an optical waveguide.

### [Table 1]

TABLE 1

| | | G1 | G2 | G3 | G4 | G5 |
|---|---|---|---|---|---|---|
| Glass | SiO₂ | 60.0 | 70.0 | 60.0 | 67.5 | 65.0 |
| Composition | Al₂O₃ | — | — | 10.0 | 2.5 | 5.0 |
| (mol %) | B₂O₃ | — | — | — | — | — |
| | MgO | 15.0 | 10.0 | 10.0 | 10.0 | 10.0 |
| | CaO | 15.0 | 10.0 | 10.0 | 10.0 | 10.0 |
| | SrO | — | — | — | — | — |
| | BaO | — | — | — | — | — |
| | Na₂O | 10.0 | 10.0 | 10.0 | 10.0 | 10.0 |
| Physical | N | 1.560 | 1.536 | 1.547 | 1.541 | 1.545 |
| Properties | CTE (×10⁻⁷/K) | 91 | 79 | 78 | 79 | 78 |
| | ε′ (@10 GHz) | 7.74 | 6.93 | 7.56 | 7.09 | 7.25 |
| | tan δ (@10 GHz) | 0.0111 | 0.0136 | 0.0157 | 0.0140 | 0.0145 |
| | | G6 | G7 | G8 | G9 | G10 |
| Glass | SiO₂ | 62.5 | 60.0 | 65.0 | 65.0 | 55.0 |
| Composition | Al₂O₃ | 7.5 | 5.0 | 2.5 | 5.0 | 5.0 |
| (mol %) | B₂O₃ | — | — | — | — | 10.0 |
| | MgO | 10.0 | 12.5 | 12.5 | 5.0 | 5.0 |
| | CaO | 10.0 | 12.5 | 12.5 | — | 10.0 |
| | SrO | — | — | — | 10.0 | 5.0 |
| | BaO | — | — | — | 5.0 | 0.0 |
| | Na₂O | 10.0 | 10.0 | 7.5 | 10.0 | 10.0 |
| Physical | N | 1.545 | 1.556 | 1.538 | 1.543 | 1.546 |
| Properties | CTE (×10⁻⁷/K) | 78 | 84 | 75 | 88 | 81 |
| | ε′ (@10 GHz) | 7.41 | 7.67 | 7.14 | 7.65 | 7.47 |
| | tan δ (@10 GHz) | 0.0151 | 0.0130 | 0.0126 | 0.0108 | 0.0109 |

TABLE 2

| | | G11 | G12 | G14 | G16 | G17 | G18 |
|---|---|---|---|---|---|---|---|
| Glass | SiO₂ | 57.7 | 65.0 | 65.0 | 69.7 | 70.5 | 63.3 |
| Composition | Al₂O₃ | 5.2 | 2.5 | 5.0 | 2.5 | 2.9 | 9.5 |
| (mol %) | B₂O₃ | 10.5 | — | — | — | 1.8 | 17.5 |
| | MgO | 0.0 | 12.5 | 5.0 | — | — | 3.0 |
| | CaO | 3.8 | 10.0 | 5.0 | 10.9 | 4.2 | 3.5 |
| | SrO | — | — | 5.0 | 9.5 | 6.2 | 2.8 |
| | BaO | 7.1 | — | — | — | 4.3 | 0.2 |
| | Na₂O | 15.7 | 10.0 | 15.0 | 7.5 | 10.0 | — |
| Physical | N | 1.538 | 1.530 | 1.528 | 1.543 | 1.538 | 1.522 |
| Properties | CTE (×10⁻⁷/K) | 94 | 81 | 96 | 77 | 80 | 34 |
| | ε′ (@10 GHz) | 7.73 | 7.26 | 7.52 | 7.08 | 7.05 | 4.8 |
| | tan δ (@10 GHz) | 0.0117 | 0.0136 | 0.0140 | 0.0106 | 0.0117 | 0.003 |

TABLE 3

| | | G′1 | G′2 | G′3 | G′4 | G′5 |
|---|---|---|---|---|---|---|
| Glass | SiO₂ | 64.0 | 63.5 | 63.9 | 61.0 | 61.9 |
| Composition | Al₂O₃ | 9.0 | 9.5 | 9.0 | 9.0 | 8.0 |
| (mol %) | B₂O₃ | 18.5 | 18.5 | 19.0 | 21.9 | 19.0 |
| | MgO | 4.0 | 2.5 | 2.5 | 4.0 | 4.0 |
| | CaO | 3.5 | 3.5 | 3.5 | 3.0 | 2.0 |
| | SrO | 0.8 | 2.3 | 1.8 | 0.8 | 1.0 |
| | BaO | 0.2 | 0.2 | 0.2 | 0.2 | 4.0 |
| | Na₂O | — | — | — | — | — |
| Physical | N | 1.519 | 1.521 | 1.520 | 1.521 | 1.528 |
| Properties | CTE (×10⁻⁷/K) | 32 | 33 | 32 | 33 | 37 |
| | ε′ (@10 GHz) | 4.6 | 4.7 | 4.7 | 4.5 | 4.9 |
| | tan δ (@10 GHz) | 0.002 | 0.003 | 0.002 | 0.002 | 0.003 |
| | | G′6 | G′7 | G′8 | G′9 | G′10 |
| Glass | SiO₂ | 63.3 | 63.0 | 63.5 | 63.3 | 63.5 |
| Composition | Al₂O₃ | 8.5 | 9.5 | 9.5 | 9.5 | 9.5 |
| (mol %) | B₂O₃ | 19.5 | 18.5 | 18.5 | 17.5 | 16.5 |
| | MgO | 2.5 | 3.5 | 3.0 | 3.0 | 3.0 |
| | CaO | 3.5 | 3.5 | 3.5 | 3.5 | 4.0 |
| | SrO | 2.3 | 1.8 | 1.8 | 2.8 | 3.3 |
| | BaO | 0.2 | 0.2 | 0.2 | 0.2 | 0.2 |
| | Na₂O | — | — | — | — | — |
| Physical | N | 1.521 | 1.521 | 1.521 | 1.522 | 1.524 |
| Properties | CTE (×10⁻⁷/K) | 35 | 33 | 33 | 34 | 36 |
| | ε′ (@10 GHz) | 4.7 | 4.7 | 4.7 | 4.8 | 4.9 |
| | tan δ (@10 GHz) | 0.002 | 0.003 | 0.003 | 0.003 | 0.003 |

TABLE 4

| | | G′11 | G′12 | G′13 | G′14 | G′15 | G′16 |
|---|---|---|---|---|---|---|---|
| Glass | SiO₂ | 66.0 | 60.7 | 60.8 | 62.1 | 59.4 | 59.2 |
| Composition | Al₂O₃ | 11.5 | 9.1 | 9.5 | 9.1 | 10.5 | 10.5 |
| (mol %) | B₂O₃ | 7.6 | 14.8 | 16.2 | 16.4 | 16.3 | 16.2 |
| | MgO | 5.2 | 3.3 | 1.0 | 1.0 | 2.9 | 2.9 |
| | CaO | 4.4 | 4.3 | 5.7 | 5.8 | 5.4 | 5.6 |
| | SrO | 5.1 | 3.2 | 1.9 | 1.9 | 0.2 | 0.2 |
| | BaO | 0.1 | 0.2 | 0.0 | 0.0 | 1.1 | 0.9 |
| | Na₂O | — | — | — | — | — | — |
| Physical | N | 1.527 | 1.525 | 1.523 | 1.523 | 1.525 | 1.525 |
| Properties | CTE (×10⁻⁷/K) | 36 | 35.6 | 34.0 | 34.2 | 33.9 | 34.0 |
| | ε′ (@10 GHz) | 5.40 | 5.0 | 4.8 | 4.8 | 4.9 | 4.8 |
| | tan δ (@10 GHz) | 0.005 | 0.0031 | 0.0025 | 0.0028 | 0.0030 | 0.0031 |

| | | G′17 | G′18 | G′19 | G′20 | G′21 |
|---|---|---|---|---|---|---|
| Glass | SiO₂ | 59.5 | 59.4 | 59.5 | 59.6 | 60.1 |
| Composition | Al₂O₃ | 10.5 | 10.4 | 10.6 | 10.6 | 8.0 |
| (mol %) | B₂O₃ | 16.2 | 16.1 | 16.3 | 16.3 | 18.9 |
| | MgO | 2.9 | 2.8 | 3.8 | 4.8 | 5.7 |
| | CaO | 5.1 | 5.8 | 4.7 | 3.7 | 0.9 |
| | SrO | 0.2 | 0.2 | 0.2 | 0.2 | 0.8 |
| | BaO | 0.9 | 0.2 | 0.9 | 0.9 | 0.2 |
| | Na₂O | — | — | — | — | — |
| Physical | N | 1.523 | 1.523 | 1.523 | 1.522 | 1.516 |
| Properties | CTE (×10⁻⁷/K) | 33.3 | 33.5 | 33.3 | | 31.1 |
| | ε′ (@10 GHz) | 4.8 | 4.8 | 4.9 | 4.8 | 4.5 |
| | tan δ (@10 GHz) | 0.0029 | 0.0028 | 0.0030 | 0.0030 | 0.0021 |

TABLE 5

| | | A1 | A2 | A3 | A4 | A5 | A6 | A7 |
|---|---|---|---|---|---|---|---|---|
| Base glass | | G1 | G2 | G4 | G5 | G6 | G7 | G8 |
| 1st | Ag salt | Ag: 5% | Ag: 5% | Ag: 5% | Ag: 5% | Ag: 5% | Ag: 5% | Ag: 5% |
| | | Na: 95% | Na: 95% | Na: 95% | Na: 95% | Na: 95% | Na: 95% | Na: 95% |
| | Temp. 1 (°C) | 400 | 400 | 400 | 400 | 400 | 400 | 400 |
| | Hold time 1 (hr) | 4.1 | 0.7 | 0.4 | 0.3 | 0.2 | 0.6 | 1.7 |
| 2nd | Na salt | — | — | — | — | — | — | — |
| | Temp. 2 (°C) | | | | | | | |
| | Hold time 2 (hr) | | | | | | | |
| [Ag] (core region) | | 6.9 | 7.2 | 6.1 | 5.3 | 4.9 | 6.7 | 4.2 |
| (mol %) | | | | | | | | |
| [Na] (core region) | | 3.1 | 2.8 | 3.9 | 4.7 | 5.1 | 3.3 | 3.3 |
| (mol %) | | | | | | | | |
| Nmax | | 1.606 | 1.584 | 1.581 | 1.580 | 1.578 | 1.601 | 1.566 |
| Refractive index | | 0.046 | 0.048 | 0.040 | 0.035 | 0.032 | 0.045 | 0.028 |
| change (Δn) | | | | | | | | |
| | | A8 | A9 | A10 | A11 | A12 | A13 | A14 |
| Base glass | | G9 | G10 | G11 | G12 | G16 | G17 | G18 |
| 1 st | Ag salt | Ag: 5% | Ag: 5% | Ag: 5% | Ag: 5% | Ag: 5% | Ag: 5% | Ag: 5% |
| | | Na: 95% | Na: 95% | Na: 95% | Na: 95% | Na: 95% | Na: 95% | Na: 95% |
| | Temp. 1 (°C) | 400 | 400 | 400 | 400 | 400 | 400 | 400 |
| | Hold time 1 (hr) | 1.5 | 1.6 | 0.3 | 0.6 | 3.8 | 1.1 | 1.0 |
| 2nd | Na salt | — | — | — | — | — | — | — |
| | Temp. 2 (°C) | | | | | | | |
| | Hold time 2 (hr) | | | | | | | |

| | | | | | | | |
|---|---|---|---|---|---|---|---|
| [Ag] (core region) | 7.0 | 4.8 | 8.4 | 6.6 | 5.1 | 6.8 | 0.0 |
| (mol %) | | | | | | | |
| [Na] (core region) | 3.0 | 5.2 | 7.3 | 3.4 | 2.4 | 3.2 | 0.0 |
| (mol %) | | | | | | | |
| Nmax | 1.590 | 1.578 | 1.594 | 1.574 | 1.577 | 1.583 | 1.522 |
| Refractive index | 0.046 | 0.032 | 0.056 | 0.044 | 0.034 | 0.045 | 0.000 |
| change (Δn) | | | | | | | |

TABLE 6

| | | A15 | A16 | A17 | A18 | A19 | A20 | A21 | A22 |
|---|---|---|---|---|---|---|---|---|---|
| Base glass | | G1 | G2 | G3 | G4 | G5 | G6 | G7 | G8 |
| 1st | Ag salt | Ag: 1% | Ag: 1% | Ag: 1% | Ag: 1% | Ag: 1% | Ag: 1% | Ag: 1% | Ag: 1% |
| | | Na: 99% | Na: 99% | Na: 99% | Na: 99% | Na: 99% | Na: 99% | Na: 99% | Na: 99% |
| | Temp. 1 (°C) | 400 | 400 | 400 | 400 | 400 | 400 | 400 | 400 |
| | Hold time 1 | 5.07 | 0.85 | 0.10 | 0.53 | 0.23 | 0.17 | 0.78 | 1.65 |
| | (hr) | | | | | | | | |
| 2nd | Na salt | — | — | — | — | — | — | — | — |
| | Temp. 2 (°C) | | | | | | | | |
| | Hold time 2 | | | | | | | | |
| | (hr) | | | | | | | | |

| | | | | | | | | |
|---|---|---|---|---|---|---|---|---|
| [Ag] (core region) | 4.7 | 3.4 | 1.5 | 2.7 | 2.0 | 1.8 | 2.7 | 1.7 |
| (mol %) | | | | | | | | |
| [Na] (core region) | 5.3 | 6.6 | 8.5 | 7.3 | 8.0 | 8.2 | 7.3 | 5.8 |
| (mol %) | | | | | | | | |
| Nmax | 1.591 | 1.558 | 1.556 | 1.559 | 1.558 | 1.557 | 1.574 | 1.549 |
| Refractive index | 0.031 | 0.023 | 0.010 | 0.018 | 0.014 | 0.012 | 0.018 | 0.011 |
| change (Δn) | | | | | | | | |

| | | A23 | A24 | A25 | A26 | A27 | A28 | A29 |
|---|---|---|---|---|---|---|---|---|
| Base glass | | G9 | G10 | G11 | G12 | G14 | G16 | G17 |
| 1st | Ag salt | Ag: 1% | Ag: 1% | Ag: 1% | Ag: 1% | Ag: 1% | Ag: 1% | Ag: 1% |
| | | Na: 99% | Na: 99% | Na: 99% | Na: 99% | Na: 99% | Na: 99% | Na: 99% |
| | Temp. 1 (°C) | 400 | 400 | 400 | 400 | 400 | 400 | 400 |
| | Hold time 1 (hr) | 1.38 | 3.27 | 0.57 | 0.75 | 0.22 | 4.73 | 1.32 |
| 2nd | Na salt | — | — | — | — | — | — | — |
| | Temp. 2 (°C) | | | | | | | |
| | Hold time 2 (hr) | | | | | | | |

| | | | | | | | |
|---|---|---|---|---|---|---|---|
| [Ag] (core region) | 3.6 | 1.8 | 4.8 | 2.7 | 6.8 | 2.7 | 3.3 |
| (mol %) | | | | | | | |
| [Na] (core region) | 6.4 | 8.2 | 10.9 | 7.3 | 8.2 | 4.8 | 6.7 |
| (mol %) | | | | | | | |
| Nmax | 1.567 | 1.558 | 1.570 | 1.549 | 1.573 | 1.561 | 1.560 |
| Refractive index | 0.024 | 0.012 | 0.032 | 0.018 | 0.045 | 0.018 | 0.022 |
| change (Δn) | | | | | | | |

TABLE 7

| | | A30 | A31 | A32 | A33 | A34 | A35 | A36 |
|---|---|---|---|---|---|---|---|---|
| Base glass | | G1 | G2 | G4 | G5 | G6 | G7 | G8 |
| 1st | Ag salt | Ag: 5% | Ag: 5% | Ag: 20% | Ag: 5% | Ag: 5% | Ag: 10% | Ag: 5% |
| | | Na: 95% | Na: 95% | Na: 80% | Na: 95% | Na: 95% | Na: 90% | Na: 95% |
| | Temp. 1 (°C) | 350 | 450 | 300 | 450 | 350 | 300 | 450 |
| | Hold time 1 | 4.1 | 0.7 | 0.4 | 0.3 | 0.2 | 0.6 | 1.7 |
| | (hr) | | | | | | | |
| 2nd | Na salt | Na: 100% | Na: 100% | Na: 100% | Na: 100% | Na: 100% | Na: 100% | Na: 100% |
| | Temp. 2 (°C) | 400 | 350 | 350 | 400 | 350 | 450 | 400 |
| | Hold time 2 | 0.5 | 1 | 1 | 0.5 | 0.5 | 0.5 | 1 |
| | (hr) | | | | | | | |

| | | | | | | | |
|---|---|---|---|---|---|---|---|
| [Ag] (core region) | 3.3 | 4.0 | 2.4 | 2.8 | 1.9 | 1.7 | 1.9 |
| (mol %) | | | | | | | |
| [Na] (core region) | 6.7 | 6.0 | 7.6 | 7.2 | 8.1 | 8.3 | 5.6 |
| (mol %) | | | | | | | |
| Nmax | 1.582 | 1.562 | 1.557 | 1.563 | 1.558 | 1.567 | 1.551 |
| Refractive index | 0.0218 | 0.0265 | 0.0161 | 0.0185 | 0.0129 | 0.0112 | 0.0127 |
| change (Δn) | | | | | | | |

| | | A37 | A38 | A39 | A40 | A41 | A42 |
|---|---|---|---|---|---|---|---|
| Base glass | | G9 | G10 | G11 | G12 | G16 | G17 |
| 1st | Ag salt | Ag: 20% | Ag: 5% | Ag: 1% | Ag: 5% | Ag: 10% | Ag: 5% |
| | | Na: 80% | Na: 95% | Na: 99% | Na: 95% | Na: 90% | Na: 95% |
| | Temp. 1 (°C) | 300 | 350 | 400 | 400 | 400 | 400 |
| | Hold time 1 (hr) | 1.5 | 1.6 | 0.6 | 0.6 | 3.8 | 1.1 |
| 2nd | Na salt | Na: 100% | Na: 100% | Na: 100% | Na: 100% | Na: 100% | Na: 100% |
| | Temp. 2 (°C) | 350 | 400 | 350 | 400 | 400 | 400 |
| | Hold time 2 (hr) | 1 | 0.5 | 1 | 0.5 | 1 | 1 |

| | | | | | | |
|---|---|---|---|---|---|---|
| [Ag] (core region) | 2.6 | 1.6 | 1.6 | 3.3 | 2.4 | 3.3 |
| (mol %) | | | | | | |
| [Na] (core region) | 7.4 | 8.4 | 14.1 | 6.7 | 5.1 | 6.7 |
| (mol %) | | | | | | |
| Nmax | 1.561 | 1.557 | 1.549 | 1.552 | 1.559 | 1.559 |
| Refractive index | 0.0171 | 0.0109 | 0.0107 | 0.0218 | 0.0162 | 0.0216 |
| change (Δn) | | | | | | |

### <<Evaluation>>

### <Refractive Index>

As the refractive index N of the glass plates of G1 to G18 and G′1 to G′21, the refractive index of light having a wavelength of 589 nm was measured by using an automatic refractive index measurement device (KPR3000, manufactured by Shimadzu Corporation).

For the glass plate obtained through the ion exchange treatment described in A1 to A42, the refractive index was measured from the surface of the glass plate every 0.5 μm in the depth direction by using a two-beam interferometer (TD-10020, manufactured by Mizoziri Optics, Co., Ltd.), and the maximum value Nmax of the refractive index was measured. For A1 to A29, it was also confirmed that the refractive index of the glass plate surface was the maximum value Nmax and the refractive index decreased as the thickness from the glass plate surface increased.

The results are shown in Tables 1 and 7. That is, Tables 1 to 4 show the refractive index N of light having a wavelength of 589 nm of the glass plates of G1 to G18 and G′1 to G′21, and Tables 5 to 7 show the refractive index change Δn, which is a difference between the maximum value Nmax of the refractive index of the core region and the refractive index of the base glass corresponding to the refractive index N of the glass constituting the cladding region A, respectively.

### <Relative Dielectric Constant and Dielectric Loss Tangent>

The glasses of G1 to G18 and G′1 to G′21 were processed into a plate shape having a length of 30.0 mm, a width of 30.0 mm, and a thickness of 0.5 mm, and the surface of 30.0 mm×30.0 mm was polished into a mirror surface. By using a network analyzer, the relative dielectric constant ε′ and the dielectric loss tangent tan 8 at 10 GHz were measured by a slip post dielectric resonance method (SPDR method). The results are shown in Tables 1 to 4.

### <Thermal Expansion Coefficient>

For the glasses of G1 to G18 and G′1 to G′21, the thermal expansion coefficient CTE was measured by using a differential thermal dilatometer according to the method specified in JIS R3102 (1995). The measurement temperature range was 50 °C to 350 °C, and the unit was/K. A sample obtained by processing a crystallized glass plate after the heat treatment into a circular (cylindrical) shape having a diameter of 5 mm and a thickness of 20 mm was used.

The results are shown in Tables 1 to 4.

### <<Production of Optical Waveguide Substrate>>

As an aspect of the optical waveguide substrate according to the present embodiment, use can be made as the cladding layer A by adopting any one of the glasses G1 to G17 shown in Table 1 or 2 and subjecting a part thereof to ion exchange.

One aspect of the ion exchange is as shown in Tables 5 to 7, and the maximum value

Nmax of the refractive index of the core region obtained by the ion exchange is, for example, a value described in A1 to A13 and A15 to A42 of Tables 5 to 7.

On the other hand, as an aspect of the cladding layer B, any one of the glasses G1 to G18 shown in Table 1 or Table 2 and the glasses G′1 to G′21 shown in Table 3 or Table 4 can be adopted.

The combination of the cladding layer A and the cladding layer B may be adopted to satisfy desired physical properties in consideration of the refractive index, the thermal expansion coefficient, and the like thereof.

For example, the optical waveguide substrate according to the present embodiment can be realized by adopting the cladding layer A having the core regions such as A1 to A13 and A15 to A42 among A1 to A42 obtained above and using the cladding layer A in combination with the cladding layer B as appropriate. Examples thereof will be described below, but the optical waveguide substrate according to the present embodiment is not limited to the following combination.

### <Optical Waveguide Substrate 1>

Examples of the optical waveguide substrate according to the present embodiment include the following combination.

G14 glass is used as the glass of the cladding layer A, and the core region of the cladding layer A can be formed by subjecting a partial region to ion exchange with masking, under the same conditions as in A27.

G′5 glass is employed as the glass of the cladding layer B.

The cladding layer A and the cladding layer B are directly bonded by thermocompression-bonding the glass plates to each other. Thus, an optical waveguide substrate is obtained.

### <Optical Waveguide Substrate 2>

Examples of the optical waveguide substrate according to the present embodiment include the following combination.

As the cladding layer A having the core region, the same as that of the optical waveguide 1 is used.

As the cladding layer B, a sheet made of G′5 glass and a 1-μm-thickness adhesive having a refractive index of 1.5283 is adopted.

The cladding layer A and the cladding layer B are bonded to each other with the adhesive constituting the cladding layer B. Thus, an optical waveguide substrate is obtained.

### <Optical Waveguide Substrate 3>

Examples of the optical waveguide substrate according to the present embodiment include the following combination.

G2 glass is used as the glass of the cladding layer A, and the core region of the cladding layer A can be formed by subjecting a partial region to ion exchange with masking, under the same conditions as in A16.

As the cladding layer B, a sheet made of G′1 glass and a 15-μm-thickness adhesive having a refractive index of 1.559.

The cladding layer A and the cladding layer B are bonded to each other with the adhesive constituting the cladding layer B. Thus, an optical waveguide substrate is obtained.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2023-218368) filed on Dec. 25, 2023, the content of which is incorporated herein by reference.

### REFERENCE SIGNS LIST

10, 10′, 10″, 10′″ Optical waveguide substrate
11, 11′, 11″, 11′″ Cladding layer A
21, 21′, 21″, 21′″ Cladding region A
31, 31′, 31″, 31′″ Core region
12, 12′, 12″, 12′″ Cladding layer B
22, 22′, 22″, 22′″ Cladding region B
32, 32′, 32″, 32′″ Glass layer or resin layer
33, 33′, 33″, 33′″ Adhesive layer

What is claimed is:

1. An optical waveguide substrate comprising:
a cladding layer A; and
a cladding layer B bonded to the cladding layer A,
wherein the cladding layer A comprises a glass having a cladding region A and a core region having a refractive index higher than that of the cladding region A,
wherein the glass constituting the cladding region A contains, in terms of mol % on an oxide basis, 5% or more of Na₂O,
wherein the glass constituting the core region contains Na₂O and Ag₂O and has a lower content ratio of Na₂O and a higher content ratio of Ag₂O than the glass constituting the cladding region A,
wherein the core region is located in a region including a part of a surface of the cladding layer A on the cladding layer B side, and
wherein the cladding layer B contains a cladding region B having a refractive index lower than that of the core region of the cladding layer A.

2. The optical waveguide substrate according to claim 1,
wherein the cladding layer B comprises a glass layer or a resin layer, and
wherein the cladding layer A is directly bonded to the glass layer or the resin layer.

3. The optical waveguide substrate according to claim 1,
wherein the cladding layer B comprises an adhesive layer and a glass layer or a resin layer,
wherein the adhesive layer has a thickness of less than 5 μm,
wherein the cladding region B comprises the adhesive layer and the glass layer or the resin layer, and
wherein the cladding layer A and the cladding layer B are bonded via the adhesive layer.

4. The optical waveguide substrate according to claim 1,
wherein the cladding layer B comprises an adhesive layer and a glass layer or a resin layer,
wherein the adhesive layer has a thickness of 5 μm or more,
wherein the cladding region B comprises the adhesive layer, and
wherein the cladding layer A and the cladding layer B are bonded via the adhesive layer.

5. The optical waveguide substrate according to claim 3,
wherein a refractive index difference between the adhesive layer constituting the cladding region B and the glass constituting the cladding region A is 0.1 or less.

6. The optical waveguide substrate according to claim 4,
wherein a refractive index difference between the adhesive layer constituting the cladding region B and the glass constituting the cladding region A is 0 to 0.003, and
wherein the adhesive layer has a thickness of 5 μm to 100 μm.

7. The optical waveguide substrate according to claim 1,
wherein a material constituting the cladding region B has a dielectric loss tangent of 0.01 or less at 10 GHz.

8. The optical waveguide substrate according to claim 1,
wherein a material constituting the cladding region B has a thermal expansion coefficient of 5×10⁻⁷/K to 120×10⁻⁷/K.

9. The optical waveguide substrate according to claim 3,
wherein the cladding layer B comprises the adhesive layer and the glass layer, and
wherein the glass constituting the cladding region B has a lower content ratio of Na₂O than the glass constituting the cladding region A.

10. The optical waveguide substrate according to claim 1,
wherein the glass constituting the cladding region A satisfies, in terms of mol % based on oxides:
SiO₂: 45% to 80%,
Al₂O₃: 0% to 15%,
B₂O₃: 0% to 20%,
MgO, CaO, SrO, and BaO: 10% to 30% in total, and
Na₂O: 5% to 25%.

11. The optical waveguide substrate according to claim 10,
wherein the cladding layer B comprises an adhesive layer and a glass layer,
wherein the adhesive layer has a thickness of 5 μm or more,
wherein the cladding region B comprises the adhesive layer, and
wherein the glass constituting the glass layer of the cladding layer B satisfies, in terms of mol % based on oxides:
SiO₂: 57% to 70%,
Al₂O₃: 5% to 15%,
B₂O₃: 15% to 24%,
MgO: 0.1% to 10%,
CaO: 0.1% to 10%,
SrO: 0.1% to 10%,
BaO: 0% to 10%, and
ZnO: 0% to 0.1%.

12. The optical waveguide substrate according to claim 1,
wherein a difference between the maximum value of a refractive index in the core region and a refractive index in the cladding region A is from 0.003 to 0.06 in the cladding layer A.

13. An optical device comprising:
the optical waveguide substrate according to claim 1; and
an optical coupler that extracts at least a part of light transmitted by the optical waveguide substrate to the outside.
